(19) United States
(12) Patent Application Publication
(10) Pub. No.: US 2026/0230209 A1
(43) Pub. Date: Aug. 6, 2026

(54) SYSTEM, DEVICE, METHOD, AND NON-TRANSITORY COMPUTER-READABLE MEDIUM

(71) Applicant: NEC Corporation, Tokyo (JP)

(72) Inventors: Takeo ONISHI, Tokyo (JP); Eiji TAKAHASHI, Tokyo (JP); Yoshiaki NISHIKAWA, Tokyo (JP); Shohei MARUYAMA, Tokyo (JP); Kenji KAWAGUCHI, Tokyo (JP); Yoshinori WATANABE, Tokyo (JP); Masayuki UEDA, Tokyo (JP); Hideki KOZUKA, Tokyo (JP); Rumi MATSUMURA, Tokyo (JP); Katsunori DATE, Tokyo (JP)

(73) Assignee: NEC Corporation, Tokyo (JP)

(21) Appl. No.: 19/151,351

(22) PCT Filed: Feb. 3, 2023
(86) PCT No.: PCT/JP2023/003622

§ 371 Date: Jul. 28, 2025

(51) Int. Cl. H04B 17/391; H04B 17/309

(52) U.S. Cl. CPC H04B 17/391; H04B 17/309

(57) ABSTRACT

A first system (10) comprises: an acquisition unit (11) that acquires wireless quality information from a wireless network such as a radio access network (RAN); and a generation unit (12) that generates on the basis of the wireless quality information acquired by the acquisition unit (11), a radio wave fluctuation model for estimating fluctuations in radio wave quality in accordance with the wireless quality information, and generates an error rate model for estimating an error rate such as a block error rate for each modulation and coding scheme (MCS) in accordance with the radio wave quality.

### TECHNICAL FIELD

The present disclosure relates to a system, a device, a method, a program, and a non-transitory computer-readable medium.

### BACKGROUND ART

In a radio network system such as 5th Generation (5G) or Long Term Evolution (LTE), a radio quality of a reference signal received by a base station or a terminal device is measured, a modulation and coding scheme (MCS) index used for radio communication is selected based on a result of the measurement. The MCS index is an index value indicating a combination of a coding scheme and a modulation scheme. Selecting (determining) the MCS index may be referred to as selecting (determining) the MCS. For example, in a case where the terminal device measures the radio quality, the terminal device reports a channel quality indicator (CQI) index indicating the measured radio quality of the reference signal to the base station by a channel state information (CSI) report as described in NPL 1. PTL 1 describes that an error rate table including a channel condition value dimension, a transmission parameter dimension, and an error rate element is used to select a transport block size (TBS) at an appropriate error rate according to a CQI.

As a related art for optimizing the MCS index, outer loop link adaptation (OLLA) is known. In the OLLA, first, the MCS index is roughly adjusted based on the measurement result using the reference signal, and then the MCS index is gradually increased. Once a block error occurs, the MCS index is decreased, and loop control is repeated such that a block error rate (BLER) becomes a target value (for example, 10%) as an average. The block error means that a transmitted transport block cannot be correctly received by a reception side.

### CITATION LIST

### Patent Literature

PTL 1: Published Japanese Translation of PCT International Publication for patent application, No. 2012-509647

### Non Patent Literature

NPL 1: ShareTechnote, “5G/NR—CSI Report”, [online], [searched on Dec. 7, 2022], Internet <URL: https://www.sharetechnote.com/html/5G/5G_CSI_Report.html>

### SUMMARY OF INVENTION

### Technical Problem

In the OLLA, in order to determine an appropriate MCS (MCS index) satisfying a target BLER, loop control of trial and error is repeated while detecting a block error as described above. In the related art, since it is assumed to detect a block error, it is sometimes difficult to determine an appropriate MCS depending on a target BLER.

In view of such a problem, an object of the present disclosure is to provide a system, a device, a method, a program, and a non-transitory computer-readable medium that enable determination of an appropriate MCS.

### Solution to Problem

A system according to the present disclosure includes: an acquisition means for acquiring radio quality information from a radio network; and a generation means for generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

Another system according to the present disclosure includes: an acquisition means for acquiring radio quality information from a radio network; and an estimation means for estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

A device according to the present disclosure includes: an acquisition means for acquiring radio quality information from a radio network; and a generation means for generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

Another device according to the present disclosure includes: an acquisition means for acquiring radio quality information from a radio network; and an estimation means for estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

A method according to the present disclosure includes: acquiring radio quality information from a radio network; and generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

Another method according to the present disclosure includes: acquiring radio quality information from a radio network; and estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

A non-transitory computer-readable medium according to the present disclosure is a non-transitory computer-readable medium storing a program for causing a computer to execute processing of: acquiring radio quality information from a radio network; and generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

Another non-transitory computer-readable medium according to the present disclosure is a non-transitory computer-readable medium storing a program for causing a computer to execute processing of: acquiring radio quality information from a radio network; and estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

### Advantageous Effects of Invention

According to the present disclosure, it is possible to provide the system, the device, the method, the program, and the non-transitory computer-readable medium which enable the determination of an appropriate MCS.

### BRIEF DESCRIPTION OF DRAWINGS

FIG. 1 is a configuration diagram illustrating an outline of a first system according to an example embodiment.

FIG. 2 is a configuration diagram illustrating an outline of a second system according to the example embodiment.

FIG. 3 is a configuration diagram illustrating an outline of a system according to the example embodiment.

FIG. 4 is a configuration diagram illustrating an outline of a first device according to the example embodiment.

FIG. 5 is a configuration diagram illustrating an outline of a second device according to the example embodiment.

FIG. 6 is a configuration diagram illustrating an outline of a device according to the example embodiment.

FIG. 7 is a flowchart illustrating an outline of a first method according to the example embodiment.

FIG. 8 is a flowchart illustrating an outline of a second method according to the example embodiment.

FIG. 9 is a configuration diagram illustrating a configuration example of a RAN system according to a first example embodiment.

FIG. 10 is a configuration diagram illustrating a configuration example of each device of the RAN system according to the first example embodiment.

FIG. 11 is a view illustrating an example of a radio wave fluctuation model according to the first example embodiment.

FIG. 12 is a view illustrating an example of a transmission error model according to the first example embodiment.

FIG. 13 is a configuration diagram illustrating another configuration example of each device of the RAN system according to the first example embodiment.

FIG. 14 is a view illustrating an outline of a method of generating the radio wave fluctuation model and the transmission error model according to the first example embodiment.

FIG. 15 is a view illustrating another example of the radio wave fluctuation model according to the first example embodiment.

FIG. 16 is a view illustrating another example of the transmission error model according to the first example embodiment.

FIG. 17 is a flowchart illustrating an operation example of learning phase processing in the RAN system according to the first example embodiment.

FIG. 18 is a view illustrating learning processing of the radio wave fluctuation model according to the first example embodiment.

FIG. 19 is a view for describing learning processing of the transmission error model according to the first example embodiment.

FIG. 20 is a view for describing a specific example of the learning processing of the transmission error model according to the first example embodiment.

FIG. 21 is a view for describing a specific example of the learning processing of the transmission error model according to the first example embodiment.

FIG. 22 is a flowchart illustrating an operation example of inference phase processing in the RAN system according to the first example embodiment.

FIG. 23 is a view illustrating inference processing of the radio wave fluctuation model and the transmission error model according to the first example embodiment.

FIG. 24 is a view illustrating another example of the inference processing of the radio wave fluctuation model and the transmission error model according to the first example embodiment.

FIG. 25 is a configuration diagram illustrating a configuration example of each device of a RAN system according to a second example embodiment.

FIG. 26 is a flowchart illustrating an operation example of learning phase processing in the RAN system according to the second example embodiment.

FIG. 27 is a view illustrating learning processing of a radio wave fluctuation learning model according to the second example embodiment.

FIG. 28 is a view illustrating learning processing of a transmission error learning model according to the second example embodiment.

FIG. 29 is a flowchart illustrating an operation example of inference phase processing in the RAN system according to the second example embodiment.

FIG. 30 is a view illustrating inference processing of the radio wave fluctuation learning model and the transmission error learning model according to the second example embodiment.

FIG. 31 is a configuration diagram illustrating another configuration example of a Near-RT RIC according to the second example embodiment.

FIG. 32 is a configuration diagram illustrating a configuration example of each device of a RAN system according to a third example embodiment.

FIG. 33 is a configuration diagram illustrating a configuration example of each device of a RAN system according to a fourth example embodiment.

FIG. 34 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary. Arrows illustrated in the drawings are examples for description, and do not limit types and directions of data.

For example, an industrial network system in a factory, a manufacturing site, or the like is required to have high reliability and a low delay. Since a transmission delay is greatly affected by a delay caused by retransmission, it is desirable to prevent the retransmission by suppressing occurrence of a block error.

The inventor has studied a method of selecting an appropriate MCS in a case where a low BLER is set as a target in order for high reliability and a low delay, and has found a problem that it is difficult to select an appropriate MCS satisfying the low BLER in OLLA, which is the related art.

Specifically, in a case where highly reliable communication with a low delay is targeted as in the industrial network system, a target BLER has a low value of 10⁻⁵, for example. In this case, in the OLLA, a long time is required for a loop of trial and error, and during that time, a true value of the BLER fluctuates. Since the BLER is determined by a plurality of factors such as a fluctuation state of a radio wave quality and a data size, the BLER is adjusted to a target value by rotating the loop of trial and error in the OLLA. For example, in a case where the target BLER is set as 10, even in a case where a terminal device occupies all radio resources, a block error occurs only about once every minute to several minutes. Typically, since the terminal device occupies only some radio resources, the block error occurs only about once every several tens of minutes, and there is a possibility that a radio wave quality condition greatly fluctuates if the block error occurs. Therefore, in the OLLA, for example, it is difficult to select an appropriate MCS in a case where the target BLER is low and the radio wave quality fluctuates.

Therefore, in the example embodiment, it is possible to appropriately select the MCS even in a case where the target BLER is low and the radio wave quality fluctuates.

### Outline of Example Embodiment

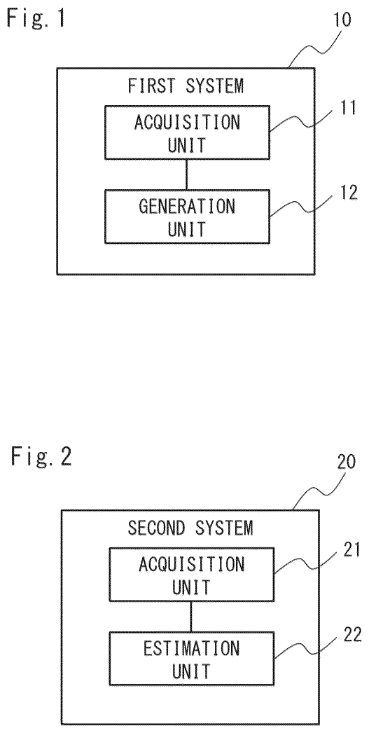

First, an outline of an example embodiment will be described. FIG. 1 illustrates a schematic configuration of a first system 10 according to the example embodiment, and FIG. 2 illustrates a schematic configuration of a second system 20 according to the example embodiment. For example, the first system 10 and the second system 20 constitute a system that controls a radio network such as a radio access network (RAN). The first system 10 and the second system 20 may be a RAN intelligent controller (RIC) that performs intelligent control in an open RAN (O-RAN) that makes a RAN open. For example, the first system 10 and the second system 20 include a Non-RT (real time) RIC and a Near-RT RIC, respectively, but are not limited thereto.

As illustrated in FIG. 1, the first system 10 includes an acquisition unit 11 and a generation unit 12. The acquisition unit 11 acquires radio quality information from the radio network. For example, the acquisition unit 11 acquires a radio wave quality such as a Wideband CQI from a RAN including an O-RAN distributed unit (O-DU) and an O-RAN central unit (0-CU). The acquisition unit 11 may acquire error rate information such as a BLER, for each MCS from the RAN.

The generation unit 12 generates an estimation model for estimating an error rate for each MCS based on the radio quality information acquired by the acquisition unit 11. The error rate for each MCS is an error rate associated with each MCS index, and is an error rate in a case where data coded and modulated by a coding system and a modulation system defined by the MCS index is transmitted. The error rate is, for example, a BLER. The estimation model may be disposed in the first system 10 or may be disposed in an external system. The estimation model is a model for estimating an error rate for each MCS at the next time from acquired past radio quality information. The next time may be a time later than the acquired radio quality information. For example, the estimation model includes a radio wave fluctuation model and an error rate model. That is, the generation unit 12 generates the radio wave fluctuation model and the error rate model based on the radio quality information.

The radio wave fluctuation model is a model for estimating a fluctuation in the radio wave quality according to the radio quality information. For example, the radio wave fluctuation model may be a calculation model for calculating the fluctuation in the radio wave quality by a predetermined calculation method. In this case, the generation unit 12 may set a parameter to be used by the radio wave fluctuation model to calculate the fluctuation in the radio wave quality based on the acquired radio quality information. The radio wave fluctuation model may be a learning model for predicting the fluctuation in the radio quality according to the radio quality information. In this case, the generation unit 12 may perform training such that the radio wave fluctuation model learns the fluctuation in the radio wave quality according to the radio quality information using the acquired radio quality information.

The error rate model is a model for estimating an error rate for each MCS according to the radio wave quality estimated by the radio wave fluctuation model. For example, the error rate model may be a calculation model for calculating an error rate for each MCS by a predetermined calculation method. In this case, the generation unit 12 may set a parameter to be used by the error rate model to calculate the error rate for each MCS based on an estimation result of the generated radio wave fluctuation model and the acquired error rate information for each MCS. The error rate model may be a learning model for predicting an error rate for each MCS according to the radio wave quality. In this case, the generation unit 12 may perform training such that the error rate model learns the error rate for each MCS according to the radio wave quality using the estimation result of the generated radio wave fluctuation model and the acquired error rate information for each MCS.

As illustrated in FIG. 2, the second system 20 includes an acquisition unit 21 and an estimation unit 22. The acquisition unit 21 acquires radio quality information from the radio network. Similarly to the acquisition unit 11 of the first system 10, the acquisition unit 21 acquires time-series data such as a Wideband CQI from the RAN.

The estimation unit 22 estimates an error rate for each MCS according to the radio quality information acquired by the acquisition unit 21 using an estimation model. The estimation model may be disposed in the second system 20 or may be disposed in an external system. The estimation unit 22 estimates an error rate for each MCS at the next time from acquired past radio quality information using the estimation model. For example, the estimation model is a model generated by the generation unit 12 of the first system, and includes the radio wave fluctuation model and the error rate model as described above. That is, the estimation unit 22 estimates the error rate for each MCS based on the radio quality information acquired by the acquisition unit 21 using the radio wave fluctuation model generated to estimate a fluctuation in a radio wave quality according to the radio quality information and the error rate model generated to estimate an error rate for each modulation and coding scheme according to the radio wave quality. The second system 20 may further include a determination unit that determines an MCS to be set in the radio network based on the error rate for each MCS estimated by the estimation unit 22.

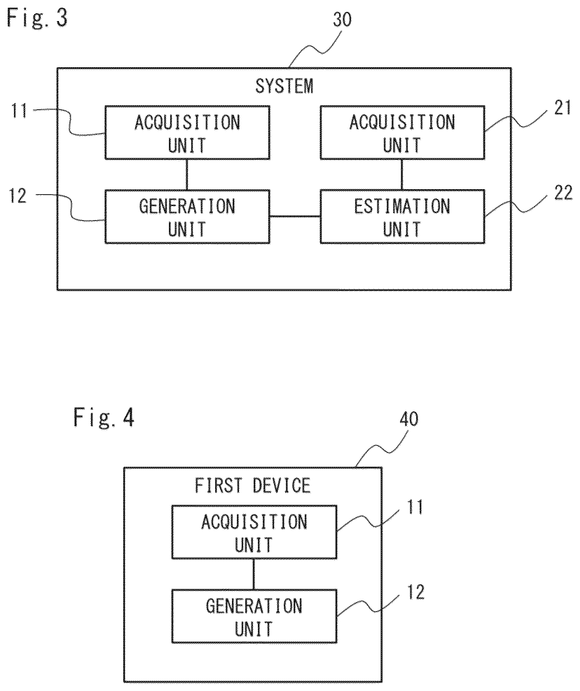

The units of the first system 10 and the second system 20 may constitute one system or a plurality of systems. FIG. 3 illustrates a configuration example of a system according to the example embodiment. For example, as illustrated in FIG. 3, a system 30 may include the units of the first system 10 and the second system 20. In this case, the acquisition unit 11 and the acquisition unit 21 may be configured as one acquisition unit. The units of the system 30 may be disposed in separate systems, respectively.

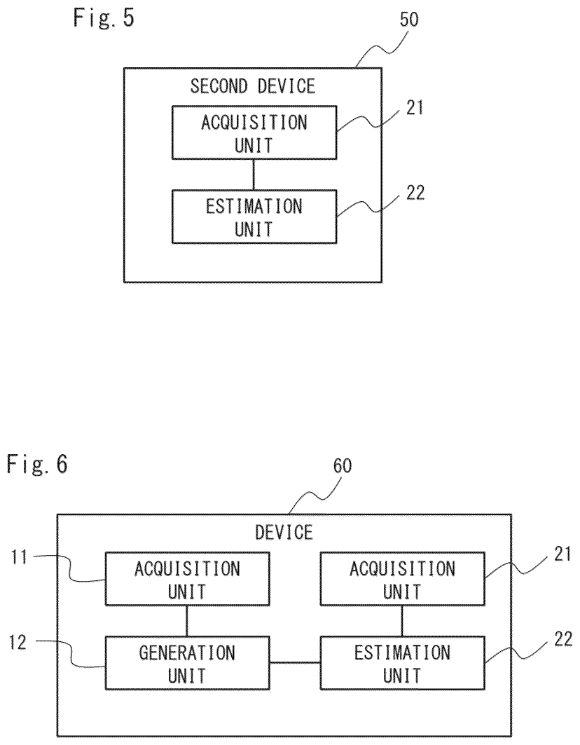

Each of the first system 10 and the second system 20 may include one device or a plurality of devices. FIG. 4 illustrates a configuration example of a first device 40 according to the example embodiment, and FIG. 5 illustrates a configuration example of a second device 50 according to the example embodiment. As illustrated in FIG. 4, the first device 40 may include the acquisition unit 11 and the generation unit 12 illustrated in FIG. 1. As illustrated in FIG. 5, the second device 50 may include the acquisition unit 21 and the estimation unit 22 illustrated in FIG. 2. Similarly to the first system 10 and the second system 20, for example, the first device 40 may be a Non-RT RIC, and the second device 50 may be a Near-RT RIC.

Similarly to configurations of the units in the first system 10 and the second system 20, the units of the first device 40 and the second device 50 may constitute one device or a plurality of devices. FIG. 6 illustrates a configuration example of a device according to the example embodiment. For example, as illustrated in FIG. 6, a device 60 may include the units of the first device 40 and the second device 50. In this case, the acquisition unit 11 and the acquisition unit 21 may be configured as one acquisition unit. The units of the device 60 may be disposed in separate devices, respectively.

Some or all of the first system 10 and the second system 20 may be disposed on an edge or a cloud by using a virtualization technology or the like. The units may be disposed at a specific place or may be disposed in a plurality of places in a distributed manner. The edge is a place or a base on the base station side including an O-DU and an O-CU. The cloud is a place or infrastructure on a core network side away from the base station. For example, the acquisition unit 11 and the generation unit 12 may be disposed in the cloud, and the acquisition unit 21 and the estimation unit 22 may be disposed in the edge. The acquisition unit 11, the generation unit 12, the acquisition unit 21, and the estimation unit 22 may be disposed in a distributed manner.

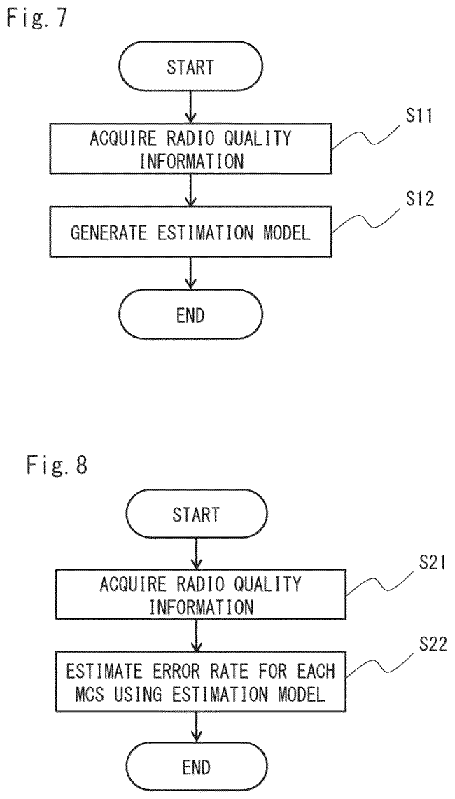

FIG. 7 illustrates a first method according to the example embodiment, and FIG. 8 illustrates a second method according to the example embodiment. For example, the first method is executed by the first system 10 in FIG. 1 or the first device 40 in FIG. 4. The second method is executed by the second system 20 in FIG. 2 or the second device 50 in FIG. 5.

As illustrated in FIG. 7, the acquisition unit 11 acquires radio quality information from the radio network (S11). Next, the generation unit 12 generates an estimation model for estimating an error rate for each MCS based on the acquired radio quality information (S12). For example, the generation unit 12 generates a radio wave fluctuation model and an error rate model using the acquired radio quality information. The generation unit 12 may generate the radio wave fluctuation model using the acquired radio quality information and generate the error rate model using an estimation result of the generated radio wave fluctuation model. The generation unit 12 may apply the generated estimation model including the radio wave fluctuation model and error rate model to the second system 20.

As illustrated in FIG. 8, the acquisition unit 21 acquires radio quality information from the radio network (S21). Next, the estimation unit 22 estimates an error rate for each MCS according to the acquired radio quality information using the estimation model (S22). The estimation unit 22 estimates the error rate for each MCS using the radio wave fluctuation model and the error rate model generated by the generation unit 12. For example, the estimation unit 22 may estimate a fluctuation in a radio wave quality according to the acquired radio quality information using the generated radio wave fluctuation model, and estimate the error rate for each MCS according to the radio wave quality estimated by the radio wave fluctuation model using the generated error rate model. Further, the second system 20 may determine an MCS to be set in the RAN based on the estimated error rate for each MCS.

As described above, in the example embodiment, the estimation model for estimating the error rate for each MCS is generated based on the radio quality information acquired from the radio network, and the error rate for each MCS is estimated using the generated estimation model. The estimation model to be generated includes the radio wave fluctuation model for estimating the fluctuation in the radio wave quality and the error rate model for estimating the error rate for each MCS. As a result, a BLER for each MCS can be accurately estimated based on the radio quality information. For example, even in a case where the radio wave quality fluctuates and a target BLER is low, the BLER for each MCS can be estimated. Therefore, it is possible to appropriately select an MCS from the estimated BLER for each MCS.

### First Example Embodiment

Next, a first example embodiment will be described. In the present example embodiment, an example in which an estimation model is generated by obtaining a parameter of a predetermined calculation model based on radio quality information collected from a RAN will be described.

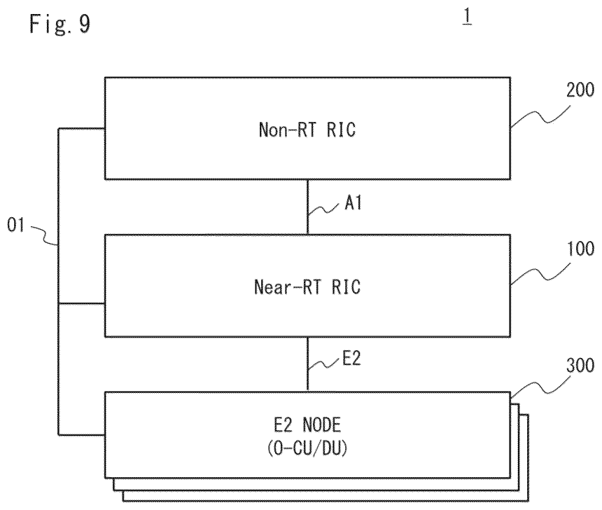

FIG. 9 illustrates a configuration example of a RAN system 1 according to the present example embodiment. As illustrated in FIG. 9, the RAN system 1 includes a Near-RT RIC 100, a Non-RT RIC 200, and an E2 node 300.

The Non-RT RIC 200 and the Near-RT RIC 100 are communicably connected to each other, and the Non-RT RIC 200 and the E2 node 300 are communicably connected to each other via an O1 interface. The O1 interface is an interface for transmitting and receiving data and messages mainly necessary for operation and management. The interface is a connection interface defined by a communication protocol for transmitting and receiving data and messages, and includes a logical transmission path, a logical network, a physical transmission path, and a physical network.

The Non-RT RIC 200 and the Near-RT RIC 100 are communicably connected via an A1 interface. The Near-RT RIC 100 and the E2 node 300 are connected via an E2 interface. The A1 interface and the E2 interface are interfaces for transmitting and receiving data and messages mainly necessary for control.

The E2 node 300 is a node constituting the RAN and includes an O-DU and an O-CU. Either or both of the O-DU and the O-CU may be referred to as the E2 node 300. The RAN is a radio network accessed by user equipment (UE), and is connected to a core network such as a 5G Core Network (5GC) or an Evolved Packet Core (EPC). The RAN may include an O-RAN Remote Unit (O-RU) constituting an antenna. The UE is a terminal device that is connected to the RAN and performs radio communication, and may be a mobile phone, a smartphone, a tablet terminal, an Internet of Things (IoT) terminal, or the like. The UE may be an application device such as a robot, a drone, or an autonomous vehicle that implements a function of a terminal.

The E2 node 300 including the O-DU and the O-CU provides a base station function. The base station is, for example, a next Generation Node B (gNB) or an evolved Node B (eNB), but is not limited thereto. The O-DU and the O-CU are examples of nodes that provide the base station function, and may be other network nodes.

The O-DU is a logical node that provides a radio signal control function and a layer 2 control function of the base station. The O-DU accommodates the O-RU and performs control of a radio signal (beam) of an antenna in the accommodated O-RU and protocol processing such as Media Access Control (MAC) or Radio Link Control (RLC) necessary between the O-RU and the O-CU.

The O-CU is a logical node that provides a radio resource control function of the base station and a data processing function higher than the layer 2. The O-CU accommodates the O-DU and performs data transmission/reception via the accommodated O-DU, Quality of Service (QoS) control, cell/UE management, handover control, and protocol processing such as Packet Data Convergence Protocol (PDCP), Service Data Adaptation Protocol (SDAP), and Radio Resource Control (RRC) necessary between the O-DU and the core network.

The E2 node 300 may include any number of O-DUs and O-CUs of 1 or more. That is, a plurality of base stations may be included. The O-DU and the O-CU are not necessarily the same number. The O-DU and the O-CU may be disposed at different places, or may be disposed at the same place. The O-DU and the O-CU may be implemented by different virtual machines operating on the virtualization infrastructure of the edge, or the same virtual machine. The O-DU and the O-CU may be a virtualized Distributed Unit (vDU) and a virtualized Central Unit (vCU), and may constitute a virtual base station. The O-DU and the O-CU may be physical DU and CU. The E2 node 300 may be a base station device including functions of the O-DU and the O-CU.

The Near-RT RIC 100 is a logical function that controls and optimizes the RAN in near real time. The Near-RT RIC 100 controls the RAN with a short control cycle of, for example, equal to or more than 10 ms (milliseconds: the same applies hereinafter) and less than 1 s (seconds: the same applies hereinafter). The Near-RT RIC 100 collects and analyzes radio information from the E2 node 300 including either or both of the O-DU and the O-CU via the E2 interface, and controls the E2 node 300 according to the radio information. The Near-RT RIC 100 may include a machine learning model that is a trained model, and analyze the radio information and specify control of the RAN by the machine learning model. Other models having similar functions may be used without being limited to the machine learning model.

For example, the Near-RT RIC 100 performs control according to the radio information in accordance with a control policy acquired from the Non-RT RIC 200 via the A1 interface. The control policy is a policy related to control of the RAN, and is, for example, an A1 policy. The A1 policy is guidance used for RAN optimization defined in the A1 interface. The Near-RT RIC 100 is disposed at the same place as either or both of the O-DU and the O-CU, or at a place near either or both of the O-DU and the O-CU. For example, the Near-RT RIC 100 may be implemented in a virtual machine of the same edge as either or both of the O-DU and the O-CU.

The Non-RT RIC 200 is a logical function that controls and optimizes the RAN in non-real time. The Non-RT RIC 200 controls the RAN with a long control cycle of, for example, equal to or more than 1 s. The Non-RT RIC 200 manages a control policy, manages operations of the E2 node 300 and the Near-RT RIC 100, trains (generates) and updates the machine learning model, or other models.

For example, the Non-RT RIC 200 generates a control policy and notifies the Near-RT RIC 100 of the generated control policy via the A1 interface. The Non-RT RIC 200 manages and sets configuration information (Configuration) of the E2 node 300 based on data acquired from the E2 node 300 or the Near-RT RIC 100 via the O1 interface. The Non-RT RIC 200 is disposed in a Service Management and Orchestration (SMO) that manages and orchestrates the RAN. The SMO is disposed at a place away from the E2 node 300 and the Near-RT RIC 100, for example, on the cloud. The Non-RT RIC 200 may include a function of SMO.

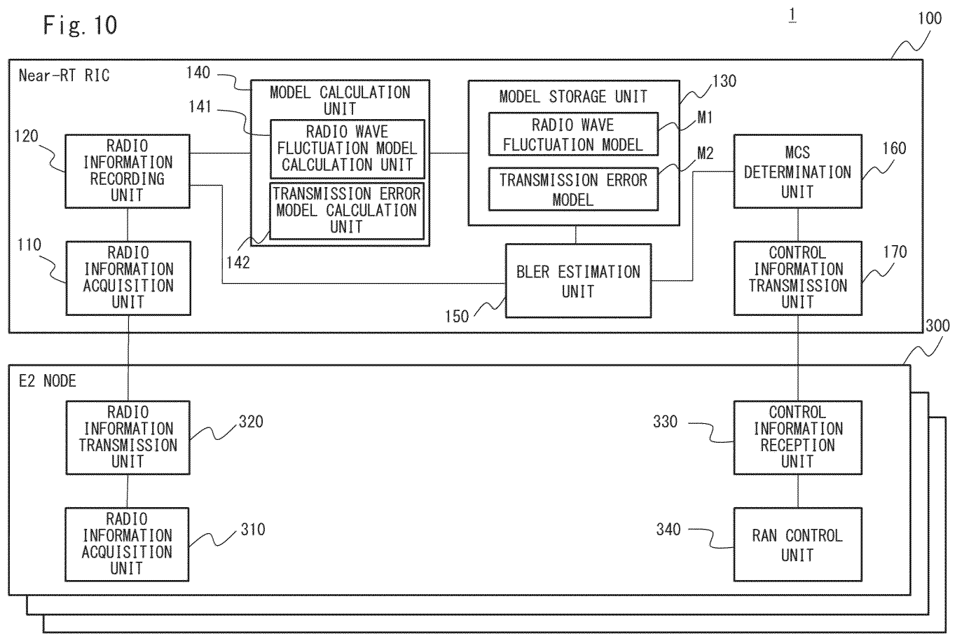

FIG. 10 illustrates a configuration example of the Near-RT RIC 100 and the E2 node 300 in the RAN system 1 according to the present example embodiment. As illustrated in FIG. 10, the E2 node 300 includes a radio information acquisition unit 310, a radio information transmission unit 320, a control information reception unit 330, and a RAN control unit 340.

The radio information acquisition unit 310 acquires radio information of the RAN. The radio information acquisition unit 310 acquires information stored in the O-DU or the O-CU or radio information from the UE or the O-RU according to an instruction from the Near-RT RIC 100. The radio information acquisition unit 310 acquires, for example, radio quality information collected from the UE and radio quality information measured by the E2 node 300 as the radio information. The radio information is not limited to the radio quality information, and may include other information necessary for control of the RAN.

For example, the radio quality information includes a radio wave quality such as a Wideband CQI. The Wideband CQI is a CQI value measured by the UE and notified to the E2 node 300 through a CSI report, or a CQI value measured by the E2 node 300. For example, a base station including the E2 node 300 sends a reference signal (CSI-RS: Channel State Information-Reference Signal) for downlink channel quality measurement to the UE, and the UE measures a quality of the received reference signal and notifies the base station of a CQI value of the measured result through a CSI report. The UE transmits a reference signal (SRS: Sounding Reference Signal) for uplink channel quality measurement to the base station including the E2 node 300, and the base station measures a quality of the received reference signal and obtains a CQI value from the measured result.

The radio wave quality may be a subband CQI, a signal to Interference plus noise power ratio (SINR), reference signal received power (RSRP), reference signal received quality (RSRQ), received signal strength indicator (RSSI), or the like.

The radio quality information includes a BLER (transmission success rate) for each MCS. The BLER for each MCS is the number of block errors for each MCS in a predetermined period measured by the UE and notified to the E2 node 300, or the number of block errors for each MCS or degree of multiple-input and multiple-output (MIMO) multiplexing in a predetermined period measured by the E2 node 300. For example, the base station including the E2 node 300 generates a transport block for downlink BLER measurement by a coding scheme and a modulation scheme of each MCS index, and transmits the generated transport block for each MCS index to the UE. The UE measures a block error of the transport block for each received MCS index and notifies the base station of the measured result. The UE generates a transport block for uplink BLER measurement by a coding scheme and a modulation scheme of each MCS index, and transmits the generated transport block for each MCS index to the base station including the E2 node 300. The base station measures a block error of the transport block for each received MCS index.

The radio information transmission unit 320 transmits the radio information including the radio quality information acquired by the radio information acquisition unit 310 to the Near-RT RIC 100 via the E2 interface. For example, the radio information transmission unit 320 transmits radio information in response to an instruction from the Near-RT RIC 100.

The control information reception unit 330 receives control information from the Near-RT RIC 100 via the E2 interface. The control information is radio control information for controlling the RAN according to the radio information, and is, for example, an MCS index for each UE. In addition, the control information may be a radio resource allocation priority, a parameter of handover control or beam control, or the like.

The RAN control unit 340 controls the RAN based on the received control information. For example, the MCS index for each UE included in the received control information is set to an MCS control unit in the O-DU or the O-CU. In addition, the RAN control unit 340 may set the radio resource allocation priority of each UE included in the received control information or the like to, for example, a radio resource control unit in the O-DU or the O-CU.

As illustrated in FIG. 10, the Near-RT RIC 100 includes a radio information acquisition unit 110, a radio information recording unit 120, a model storage unit 130, a model calculation unit 140, a BLER estimation unit 150, an MCS determination unit 160, and a control information transmission unit 170.

The radio information acquisition unit 110 receives the radio information including the radio quality information from the E2 node 300 including either or both of the O-DU and the O-CU via the E2 interface. The radio information acquisition unit 110 is also a radio quality information acquisition unit that acquires radio quality information. The radio information acquisition unit 110 collects the radio quality information from the E2 node 300 as learning data to be used by the model calculation unit 140 to calculate a parameter of an estimation model during learning phase processing (during estimation model generation processing). The radio information acquisition unit 110 collects the radio quality information from the E2 node 300 as inference data to be used by the BLER estimation unit 150 to estimate a BLER using the estimation model during inference phase processing (during estimation model estimation processing). For example, the radio information acquisition unit 110 may instruct the E2 node 300 on data to be collected and a cycle.

The radio information recording unit 120 is a database that records (stores) the radio information received from the E2 node 300. The radio information recording unit 120 accumulates the radio information including the radio quality information as time-series data. The radio information acquisition unit 110 may output the received radio information to the model calculation unit 140 and the BLER estimation unit 150.

The model storage unit 130 stores the estimation model to be used in the parameter calculation by the model calculation unit 140 and the BLER estimation by the BLER estimation unit 150. The estimation model is a model for estimating a BLER for each MCS at the next time according to time-series data of past radio quality information. A function of the estimation model may be achieved by one model or a plurality of models. In this example, the model storage unit 130 stores a radio wave fluctuation model M1 and a transmission error model M2 as the estimation model.

The radio wave fluctuation model M1 is a model for estimating a fluctuation in a radio quality (radio wave quality) from the time-series data of the radio quality information. Since the radio wave quality fluctuates depending on time and frequency, the radio wave fluctuation model M1 estimates a radio wave quality that fluctuates depending on time and frequency. The radio wave fluctuation model M1 estimates a radio wave quality at the next time from time-series data of past radio wave qualities. The radio wave fluctuation model M1 is a calculation model for calculating the fluctuation (probability distribution) in the radio wave quality by performing predetermined calculation using a set parameter. For example, the radio wave fluctuation model M1 is a propagation model for calculating a propagation characteristic (the number of multipaths or the like) of a radio transmission path.

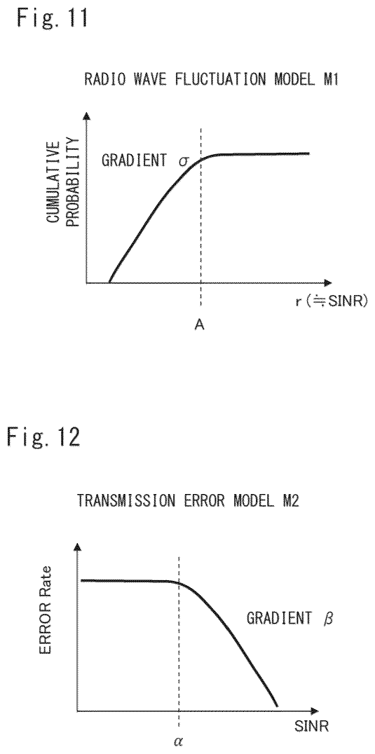

For example, in a case where the UE performs radio communication while moving, the radio wave quality fluctuates due to fading. Therefore, the radio wave fluctuation model M1 may be a fading model for calculating a propagation characteristic according to fading. The radio wave fluctuation model M1 is not limited to the fading model, and may be models for calculating other propagation characteristics. A probability distribution p(r) of the fading model can be calculated by the following probability density function (Formula 1). Formula 1 is an example of the Nakagawa-Rician fading model. FIG. 11 is a cumulative probability distribution according to the fading model of Formula 1, and illustrates a cumulative probability with respect to a radio wave intensity r (SINR). For example, the cumulative probability distribution increases as the radio wave intensity increases up to a certain radio wave intensity, and then becomes a constant value.

$$[ Mathematical Expression 1 ]$$

$$p ( r ) = \frac{r}{{σ}^{2}} exp ( - \frac{{r}^{2} + {A}^{2}}{2 {σ}^{2}} ) {I}_{0} ( \frac{rA}{{σ}^{2}} ) \qquad ( Formula 1 )$$

In Formula 1, σ corresponds to the number of reflected waves, and a has a larger value as the number of reflected waves increases. In addition, σ represents a gradient of a rise of the cumulative probability distribution in FIG. 11. In Formula 1, A defines an average value of radio wave intensities. In a case where the radio wave intensity stochastically decreases due to fading, A defines a position of a shoulder (vertex) of the cumulative probability distribution of FIG. 11. For example, the gradient σ and the shoulder position A of the cumulative probability distribution are parameters (radio wave fluctuation parameters) used to calculate the radio wave quality of the radio wave fluctuation model M1. As the parameter, either or both of the gradient a of the cumulative probability distribution and the shoulder position A may be used. In Formula 1, I₀ is the zeroth-order modified Bessel function of the first kind.

The transmission error model M2 (error rate model) is a model for estimating a BLER for each MCS from the radio quality (radio wave quality) estimated by the radio wave fluctuation model M1. An error rate (transmission error) does not fluctuate (or gently fluctuates) depending on time and frequency with a given radio quality, but depends on a base station (O-CU or O-DU), a UE, and the like. Therefore, the transmission error model M2 may estimate the BLER according to these. The transmission error model M2 is a calculation model for calculating the BLER for each MCS by performing predetermined calculation using a set parameter.

Specifically, the transmission error model M2 is a model for calculating an error rate distribution (error rate characteristic) with respect to the radio wave quality (radio quality), for each MCS. FIG. 12 illustrates the error rate distribution with respect to the radio wave quality (SINR) of a certain MCS. An SINR value can be estimated from a CQI value. For example, the error rate distribution has a constant value up to a certain radio wave quality, and then decreases as the radio wave quality increases. The transmission error model M2 can be achieved by a distribution function that calculates the error rate distribution with respect to the radio wave quality illustrated in FIG. 12. For example, the distribution function includes β that defines a gradient of a fall of the error rate distribution in FIG. 12 and α that defines a position of a shoulder (vertex). For example, the gradient β and the shoulder position α of the error rate distribution are parameters (error rate parameters) used to calculate the error rate of the transmission error model M2. As the parameter, either or both of the gradient β and the shoulder position α of the error rate distribution may be used.

The model calculation unit 140 calculates a parameter of the estimation model based on time-series data of the radio quality information (radio information) received from the E2 node 300 using the radio information acquisition unit 110 and recorded in the radio information recording unit 120. The model calculation unit 140 is a generation unit that generates the estimation model by calculating the parameter. The model calculation unit 140 stores (sets) the calculated parameter in the model storage unit 130. The model calculation unit 140 includes a radio wave fluctuation model calculation unit 141 and a transmission error model calculation unit 142. The radio wave fluctuation model calculation unit 141 calculates the parameters (the gradient σ and the shoulder position A of the cumulative probability distribution) of the radio wave fluctuation model M1 using the time-series data of the radio quality information (Wideband CQI or the like). The transmission error model calculation unit 142 calculates the parameters (the gradient β and the shoulder position α of the error rate distribution) of the transmission error model M2 using the estimation result obtained by the radio wave fluctuation model M1 for which the parameters have been calculated and the radio quality information (the error rate for each MCS).

The BLER estimation unit 150 estimates a BLER for each MCS based on the time-series radio quality information (radio information) received from the E2 node 300 using the radio information acquisition unit 110 and recorded in the radio information recording unit 120. The BLER estimation unit 150 estimates the BLER for each MCS using the estimation model for which the parameters have been calculated by the model calculation unit 140 and stored in the model storage unit 130. The BLER estimation unit 150 estimates a fluctuation (probability distribution) in the radio wave quality by the radio wave fluctuation model M1 for which the parameters have been calculated using the time-series data of the radio quality information (Wideband CQI or the like). The BLER estimation unit 150 estimates the BLER for each MCS by the transmission error model M2 for which the parameters have been calculated using the fluctuation (probability distribution) in the radio wave quality estimated by the radio wave fluctuation model M1.

The MCS determination unit 160 determines an MCS to be set in the E2 node 300 based on the BLER for each MCS estimated by the BLER estimation unit 150. The MCS determination unit 160 selects an MCS index that satisfies a target BLER from among the estimated BLERs of MCSs.

The control information transmission unit 170 transmits the control information (MCS) determined by the MCS determination unit 160 to the E2 node 300. The control information transmission unit 170 transmits the determined MCS index to the E2 node 300 including either or both of the O-DU and the O-CU via the E2 interface.

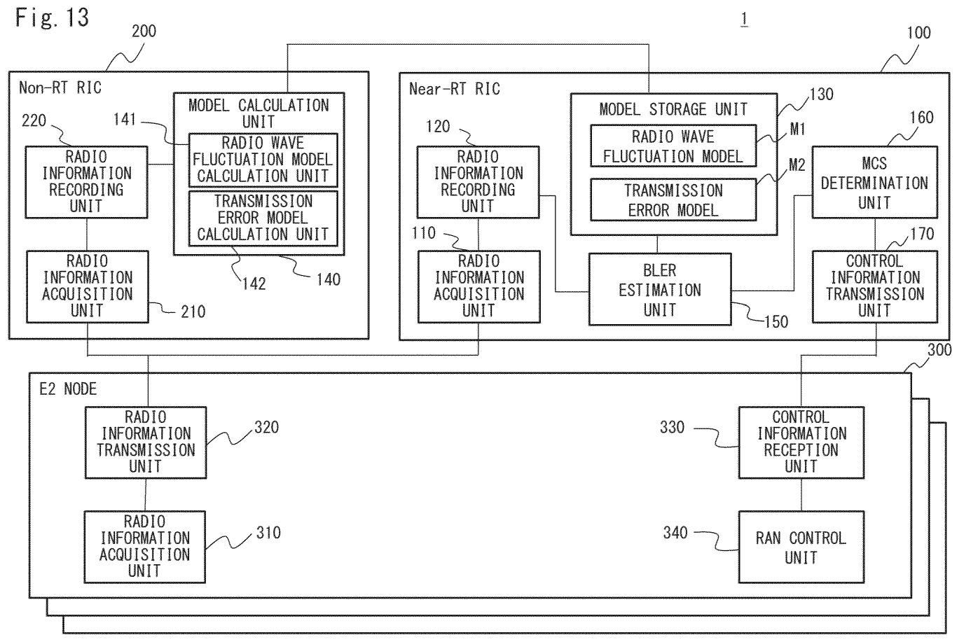

The configuration in FIG. 10 is an example, and another configuration may be used as long as the operation according to the present example embodiment described below can be performed. A part of the configuration of the Near-RT RIC 100 may be disposed in the Non-RT RIC 200. For example, as illustrated in FIG. 13, the model calculation unit 140 may be disposed in the Non-RT RIC 200. The model storage unit 130 may be disposed in the Non-RT RIC 200.

In the example of FIG. 13, the Non-RT RIC 200 includes a radio information acquisition unit 210, a radio information recording unit 220, and the model calculation unit 140. The radio information acquisition unit 210 receives the radio information including the radio quality information from the E2 node 300 including either or both of the O-DU and the O-CU via the O1 interface. The radio information acquisition unit 210 may receive the radio information of the E2 node 300 from the Near-RT RIC 100 via the O1 interface. That is, the Near-RT RIC 100 may collect the radio information from the E2 node 300 and transfer the collected radio information from the Near-RT RIC 100 to the Non-RT RIC 200.

Similarly to the radio information recording unit 120, the radio information recording unit 220 records the radio information received by the radio information acquisition unit 210 from the E2 node 300. The model calculation unit 140 calculates the parameter of the estimation model based on time-series data of the radio quality information (radio information) received from the E2 node 300 using the radio information acquisition unit 210 and recorded in the radio information recording unit 220. The model calculation unit 140 transmits the calculated parameter (generated estimation model) to the Near-RT RIC 100 and stores the parameter in the model storage unit 130.

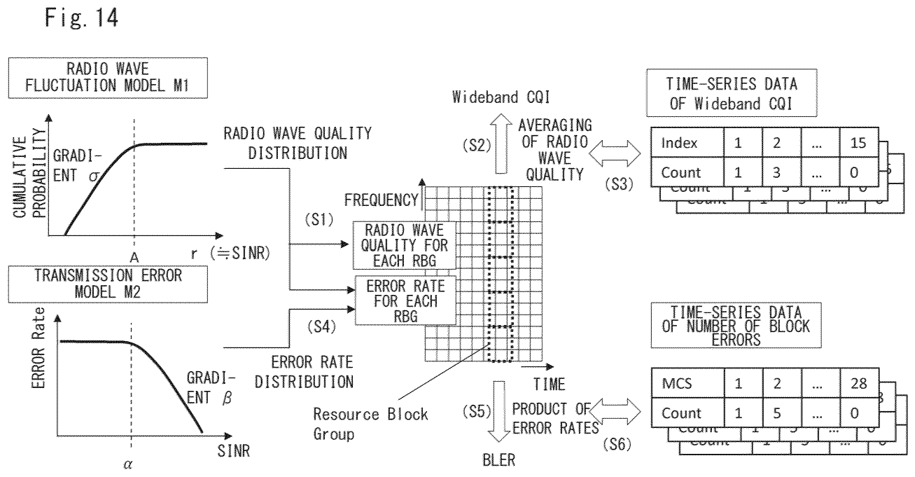

FIG. 14 illustrates an outline of a method of generating the radio wave fluctuation model M1 and the transmission error model M2. During the learning phase processing, first, the radio wave fluctuation model M1 calculates a radio wave quality distribution (cumulative probability distribution) by the above Formula 1 (S1). At this time, the parameters (the gradient σ and the shoulder position A of the cumulative probability distribution) of the radio wave fluctuation model M1 may be predetermined initial values.

Next, the radio wave fluctuation model calculation unit 141 calculates a Wideband CQI from the radio wave quality distribution calculated by the radio wave fluctuation model M1 (S2). Specifically, a radio wave quality of each resource block group (RBG) is obtained from the radio wave quality distribution calculated by the radio wave fluctuation model M1. The radio wave quality may be obtained not only for each RBG but also for each resource block (RB). For example, an SINR of each RBG is specified from the frequency and time of each RBG, and a cumulative probability at the specified SINR is obtained using Formula 1, thereby obtaining the radio wave quality of each RBG. Further, the obtained radio wave quality of the RBG is averaged to obtain a Wideband CQI (CQI of the entire band). The number of RBGs may be estimated from the number of MCSs and/or units of active UE.

Next, the radio wave fluctuation model calculation unit 141 calculates the parameters (the gradient a and the shoulder position A of the cumulative probability distribution) of the radio wave fluctuation model M1 from the Wideband CQI (averaged radio wave quality) obtained from the radio wave quality distribution of the radio wave fluctuation model M1 and time-series data of the Wideband CQI (radio wave quality) acquired from the E2 node 300 (S3). The Wideband CQI obtained by the radio wave fluctuation model M1 is matched with the time-series data of the Wideband CQI acquired from the E2 node 300, and the parameters of the radio wave fluctuation model M1 are estimated using Bayesian estimation, a Kalman filter, or the like. For example, the parameters of the radio wave fluctuation model M1 are calculated so as to reduce an error between the Wideband CQI obtained from the radio wave fluctuation model and the Wideband CQI acquired from the E2 node 300. For example, a distribution histogram may be created by accumulating the acquired time-series Wideband CQIs, and the parameters may be calculated by fitting the created histogram and Formula 1. In addition, estimated values of the parameters may be sequentially calculated (corrected) from the Wideband CQI observed using a method such as a Kalman filter.

Next, the radio wave fluctuation model M1 calculates a radio wave quality distribution using the calculated parameters, and the transmission error model M2 calculates an error rate distribution for each MCS (S4). At this time, the parameters (the gradient β and the shoulder position α of the error rate distribution) of the transmission error model M2 may be a predetermined initial value.

Next, the transmission error model calculation unit 142 calculates a BLER for each MCS from the radio wave quality distribution (estimation result) calculated by the radio wave fluctuation model M1 and the error rate distribution calculated by the transmission error model M2 (S5). Specifically, an error rate for each RGB is obtained from a cumulative probability of each SINR calculated by the radio wave fluctuation model M1 and the error rate of the SNIR calculated by the transmission error model M2. For example, an SINR is specified from the frequency and time of each RBG, a cumulative probability in the specified SINR is obtained by the radio wave fluctuation model M1, an error rate in the specified SINR is obtained by the transmission error model M2, and an error rate of each RBG is obtained by multiplying the obtained cumulative probability by the error rate. The error rate may be obtained not only for each RBG but also for each RB. Further, a BLER is obtained by integrating the obtained error rates of the RBGs. The BLER for each MCS is obtained using the error rate distribution for each MCS calculated by the transmission error model M2.

As described above, by the radio wave quality distribution (radio wave quality probability distribution) obtained by the radio wave fluctuation model M1 and the error rate distribution obtained by the transmission error model M2 are multiplied, a block error probability at a certain point of time is calculated. For example, assuming that a probability that the radio wave intensity becomes r1 is p1 and an error rate at r1 is P1, p1×P1 is a probability that an error occurs. In practice, the radio wave intensity may take another value, and thus a probability p2 that the radio wave intensity becomes r2 is multiplied by an error rate P2 at this radio wave intensity, for example, in the same manner for other radio field intensities. By these are added up (p1×P1+p2×P2+ . . . ), an error probability in a case where a certain MCS is used is obtained.

Next, the transmission error model calculation unit 142 calculates the parameters (the gradient β and the shoulder position α of the error rate distribution) of the transmission error model M2 from the BLER for each MCS, obtained from the radio wave quality distribution of the radio wave fluctuation model M1 and the error rate distribution of the transmission error model M2, and time-series data of the number of block errors (BLER) for each MCS acquired from the E2 node 300 (S6). The BLER for each MCS obtained by the radio wave fluctuation model M1 and the transmission error model M2 is matched with the time-series data of the number of block errors for each MCS acquired from the E2 node 300, and the parameters of the transmission error model M2 are estimated using Bayesian estimation, a Kalman filter, or the like. The parameters of the transmission error model M2 are calculated so as to reduce an error between the BLER for each MCS obtained by the radio wave fluctuation model M1 and the transmission error model M2 and the number of block errors for each MCS obtained from the E2 node 300.

An error rate can be calculated by accumulating acquired actual values of the number of block errors for a certain time. For example, in a case where the parameters of the transmission error model M2 are correct, an error probability obtained from the transmission error model M2 and the error rate obtained from the actual values of the number of block errors have substantially the same value. In a case where there is an error in the parameters of the transmission error model M2, there is a difference between the error probability obtained from the transmission error model M2 and the error rate obtained from the actual values of the number of block errors, so that the parameters of the transmission error model M2 can be adjusted to a likelihood value by adjusting the parameters in a direction of reducing the difference. For example, this adjustment is sequentially performed by a Kalman filter.

The radio wave fluctuation model calculation unit 141 may calculate the parameters of the radio wave fluctuation model M1 according to shielding or interference of radio waves in the RAN. For example, the parameters of the radio wave fluctuation model M1 may be calculated by adding a shielding intensity and a change probability to a Kalman filter, or the parameters of the radio wave fluctuation model M1 may be calculated by adding an interference intensity and a change probability to a Kalman filter. The interference intensity or the shielding intensity may be estimated from time-series data of the degree of congestion of adjacent cells, a fluctuation pattern of a radio wave quality, or the like, and the parameters of the radio wave fluctuation model M1 may be calculated using the estimated interference intensity or shielding intensity. Since a value of A in Formula 1 (the shoulder position of the cumulative probability distribution) depends on shielding and interference, a model in consideration of the shielding or the interference can be generated by incorporating a change in A into the model.

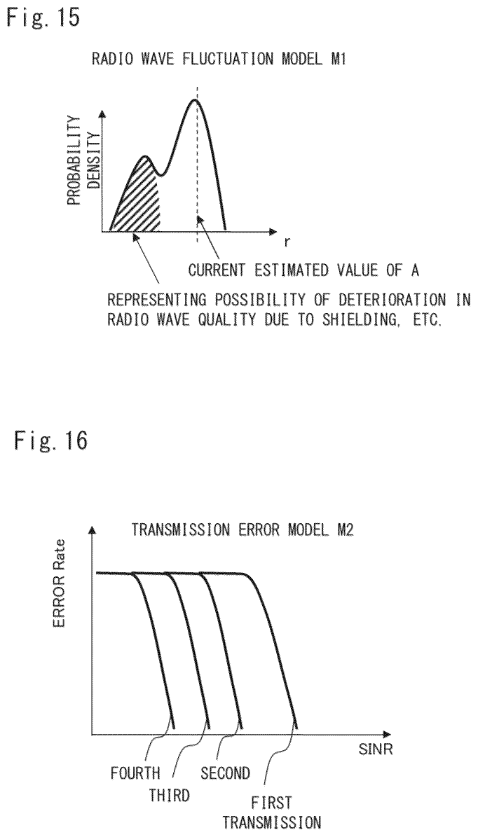

FIG. 15 illustrates an example of the radio wave fluctuation model M1 in consideration of the shielding. As illustrated in FIG. 15, for example, a shape having a tail portion (hatched portion in FIG. 15) representing a possibility of deterioration due to the shielding or the interference with a current estimated value of A calculated from the radio wave intensity as a peak may be adopted as a probability distribution. As a result, a fluctuation due to the shielding, the interference, or the like can be taken into consideration, and thus prediction accuracy of the BLER is improved.

The radio wave fluctuation model calculation unit 141 may calculate the parameters of the radio wave fluctuation model M1 according to a spatial correlation. The spatial correlation is a spatial correlation generated between antennas of base stations (O-DUs or O-CUs). Since a radio wave quality changes depending on the strength of the spatial correlation in MIMO, a probability distribution is changed according to the spatial correlation. For example, the spatial correlation may be estimated from a fluctuation pattern of the radio wave quality, and the parameters of the radio wave fluctuation model M1 may be calculated according to the magnitude of the estimated spatial correlation. For example, in a case where the spatial correlation is low (in a case where Rank is low), it is considered that the number of radio wave paths is small, so that it can be assumed that the spread of radio wave fluctuations is small. Therefore, in a case where a radio wave fluctuation model whose parameter is sequentially updated by a Kalman filter or the like is used, the strength of the spatial correlation may be detected to cause the spread (gradient component of a cumulative distribution) of fluctuations of the model to quickly follow in accordance with the detected strength of the spatial correlation. The parameters of the radio wave fluctuation model M1 may be calculated using observation values of the number of times of transmission and the number of errors for each Wideband CQI or MCS for each Rank. In a case where the observation values of the number of times of transmission and the number of errors for each Wideband CQI or MCS are collected, data may be aggregated for each degree of spatial multiplexing, and input and output for parameter calculation may be performed for each degree of multiplexing.

The transmission error model M2 may include an error rate distribution (error rate characteristic) per retransmission (per transmission). For example, as illustrated in FIG. 16, the transmission error model M2 may include error rate distributions of the second retransmission to the fourth retransmission. As illustrated in FIG. 16, as the number of times of retransmission increases, an error rate in the case of a low SINR decreases. For example, the transmission error model calculation unit 142 calculates a parameter of the error rate distribution per retransmission (per transmission). The transmission error model M2 may estimate a BLER per retransmission from each of the error rate distributions at the time of inference. As a result, the BLER per retransmission (per transmission) can be estimated for each MCS, and the MCS can be determined from the estimated BLER in consideration of the number of times of retransmission.

Next, the learning phase processing and inference phase processing in the RAN system 1 will be described. The learning phase processing is processing of calculating (learning) a parameter of an estimation model and generating the estimation model for which the parameter has been calculated (learned). The inference phase processing is processing of estimating (inferring) a BLER for each MCS by the estimation model for which the parameter has been calculated. For example, the inference phase processing may be performed after the learning phase processing, or the learning phase processing and the inference phase processing may be performed in parallel after the learning phase processing has been performed for the first time (after the parameter has been calculated once). For example, in the learning phase processing, the estimation model may be updated as needed in real time every time new data (radio quality information) is generated, or learning processing of the estimation model may be performed in advance (offline).

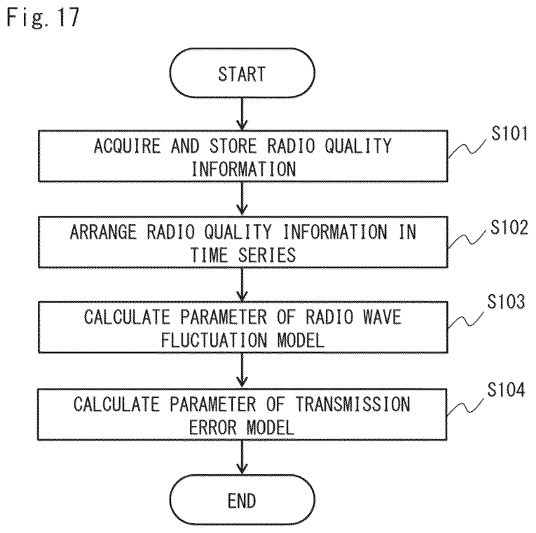

FIG. 17 illustrates an operation example of the learning phase processing in the RAN system 1 according to the present example embodiment. As illustrated in FIG. 17, the Near-RT RIC 100 acquires radio quality information and stores the acquired radio quality information (S101). For example, the radio information acquisition unit 110 receives the radio quality information from the E2 node 300, and the radio information recording unit 120 stores the received radio quality information. The radio quality information to be stored is data for parameter calculation (learning) of an estimation model, and includes, for example, a radio wave quality such as a Wideband CQI (or a CQI for each RBG) and the number of block errors (a transmission success rate) for each MCS. The radio wave quality such as the Wideband CQI is data used for parameter calculation of the radio wave fluctuation model M1, and the number of block errors for each MCS is data used for parameter calculation of the transmission error model M2.

Subsequently, the Near-RT RIC 100 arranges the stored radio quality information in time series (S102). For example, the radio information recording unit 120 acquires pieces of the stored radio quality information for a predetermined time to obtain time-series data. The model calculation unit 140 may obtain the time-series data of the radio quality information in a case where calculating parameters.

Subsequently, the Near-RT RIC 100 calculates parameters of an estimation model for estimating a BLER for each MCS from the time-series data of the radio quality information stored in the radio information recording unit 120, and generates the estimation model (S103 to S104). In this example, the learning processing of the estimation model is performed in two steps, parameters of the radio wave fluctuation model M1 is determined first, and parameters of the transmission error model M2 is calculated using the result. That is, the radio wave fluctuation model calculation unit 141 calculates the parameters of the radio wave fluctuation model M1 (S103), and then the transmission error model calculation unit 142 calculates the parameters of the transmission error model M2 (S104). The radio wave fluctuation model calculation unit 141 and the transmission error model calculation unit 142 store the calculated parameters (trained model) in the model storage unit 130.

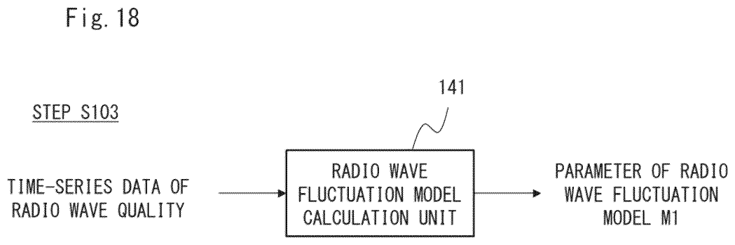

FIG. 18 illustrates input and output of the radio wave fluctuation model calculation unit 141 in S103 (a first step of the learning processing). As illustrated in FIG. 18, the radio wave fluctuation model calculation unit 141 acquires time-series data of the radio wave quality, such as a Wideband CQI, from the radio information recording unit 120, and calculates the parameters of the radio wave fluctuation model M1 based on the acquired time-series data of the radio wave quality. As described with reference to FIG. 14, the radio wave fluctuation model calculation unit 141 estimates the parameters of the radio wave fluctuation model M1 from the time-series data of the radio wave quality using Bayesian estimation, a Kalman filter, or the like. For example, the radio wave fluctuation model calculation unit 141 calculates the gradient a and the shoulder position A of the cumulative probability distribution. As the parameters related to a radio wave fluctuation, an average radio wave intensity (A in Formula 1), a K factor, an occurrence probability and an intensity of shielding, and an occurrence probability and an intensity of interference may be calculated. The K factor is a ratio between a line-of-sight wave and a non-line-of-sight wave (reflected wave). For example, the average radio wave intensity and the K factor may be calculated by fitting Formula 1, which is the radio wave fluctuation model M1 (Nakagawa-Rician fading model), to a histogram or the like generated from time-series radio wave qualities. For example, parameters may be calculated so as to obtain the radio wave fluctuation model M1 as illustrated in FIG. 15 for the occurrence probability and the intensity of shielding and the occurrence probability and the intensity of interference.

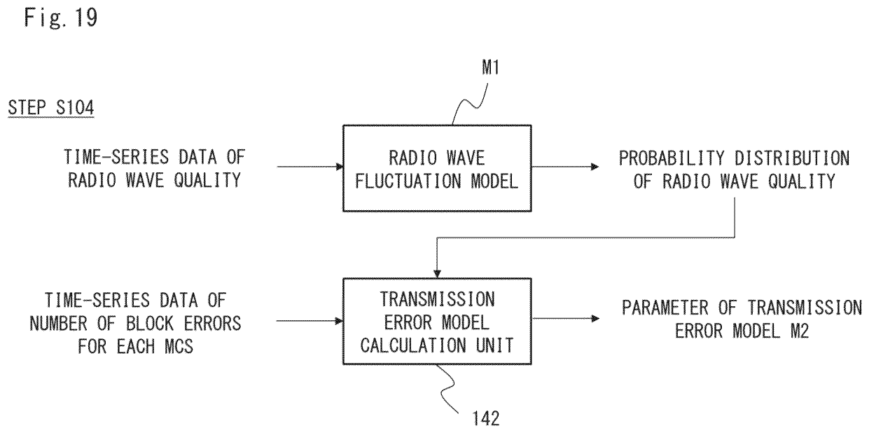

FIG. 19 illustrates input and output of the radio wave fluctuation model M1 and the transmission error model calculation unit 142 in S104 (a second step of the learning processing). As illustrated in FIG. 19, time-series data of the radio wave quality, such as a Wideband CQI, from the radio information recording unit 120 is input to the radio wave fluctuation model M1 for which the parameters have been calculated in S103 to calculate a probability distribution (cumulative probability distribution) of the radio wave quality. Next, the transmission error model calculation unit 142 acquires the time-series data of the number of block errors for each MCS from the radio information recording unit 120, and calculates the parameters of the transmission error model M2 based on the probability distribution of the radio wave quality calculated by the radio wave fluctuation model M1 and the acquired time-series data of the number of block errors for each MCS. As described with reference to FIG. 14, the transmission error model calculation unit 142 estimates the parameters of the transmission error model M2 using Bayesian estimation, a Kalman filter, or the like from the calculation result of the radio wave fluctuation model M1 and the number of block errors for each MCS. For example, the transmission error model calculation unit 142 calculates the gradient β and the shoulder position α of the error rate distribution. The calculated parameters give a block error rate for a combination of a radio quality and an MCS in a case where there is no radio fluctuation in a frequency direction and a time direction.

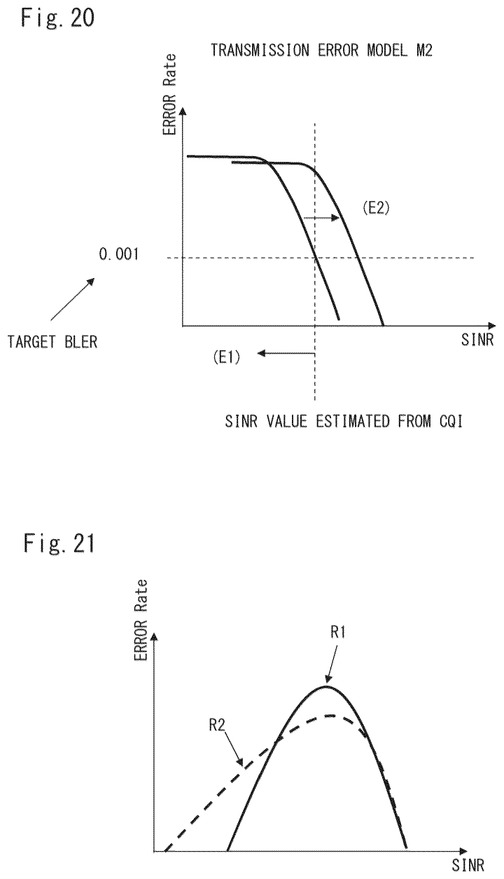

Through calculation using the probability distribution of the radio wave quality, it is possible to evaluate whether a generated block error is an error caused by a fluctuation in the radio wave quality (in the frequency and time directions) or an error caused by a low MCS with respect to a radio wave quality value, and it is possible to calculate the parameters of the transmission error model M2 according to the evaluation result. Specifically, as illustrated in FIG. 20, as a probability of a radio wave fluctuation (radio wave quality) is given, it is possible to estimate, in a case where an error has occurred, whether the error has occurred because the SINR decreases due to the fluctuation (a case indicated by arrow E1) or the error has occurred because the transmission error model itself has underestimated the error rate (a case indicated by arrow E2). For example, if a probability that the radio wave quality decreases due to the fluctuation is high, the transmission error model itself is not corrected assuming the case E1. Conversely, if the probability that the radio wave quality decreases is low, the transmission error model is corrected in a direction in which the error rate is not underestimated assuming the case E2. A case where the probability that the radio wave quality decreases is high is a case where the probability increases as the radio wave quality is lower. For example, as illustrated in FIG. 21, a distribution R2 has a larger skirt of the distribution than a distribution R1 of the radio wave quality, and the probability that the radio wave quality fluctuates is high since the probability increases as the radio wave quality is lower.

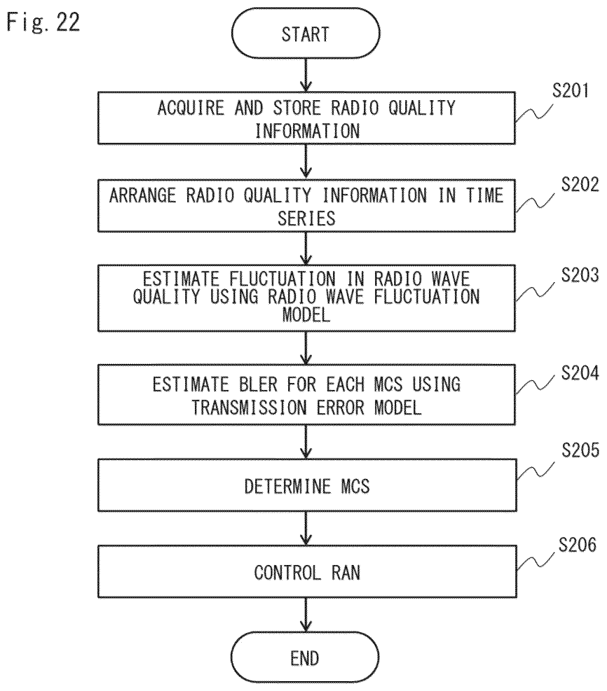

FIG. 22 illustrates an operation example of the inference phase processing in the RAN system 1 according to the present example embodiment. As illustrated in FIG. 22, the Near-RT RCI 100 acquires radio quality information and stores the acquired radio quality information (S201). Similarly to S101 of FIG. 17, the radio information acquisition unit 110 receives the radio quality information from the E2 node 300, and the radio information recording unit 120 stores the received radio quality information. The radio quality information to be stored is data for estimation (inference) of an estimation model, and includes a radio wave quality such as a Wideband CQI. The radio wave quality such as the Wideband CQI is data used by the radio wave fluctuation model M1 for estimation of a radio wave fluctuation.

Subsequently, the Near-RT RIC 100 arranges the stored radio quality information in time series (S202). Similarly to S102 of FIG. 17, the radio information recording unit 120 acquires pieces of the stored radio quality information for a predetermined time to obtain time-series data. The BLER estimation unit 150 may obtain the time-series data of the radio quality information in a case where estimating a BLER.

Subsequently, the Near-RT RIC 100 estimates the BLER for each MCS from the time-series data of the radio quality time information stored in the radio information recording unit 120 using the estimation model for which parameters have been calculated and which is stored in the model storage unit 130 (S203 to S204). Specifically, the BLER estimation unit 150 estimates a fluctuation in a radio wave quality using the radio wave fluctuation model M1 for which the parameters have been calculated (S203), and estimates the BLER for each MCS using the transmission error model M2 for which the parameters have been calculated (S204).

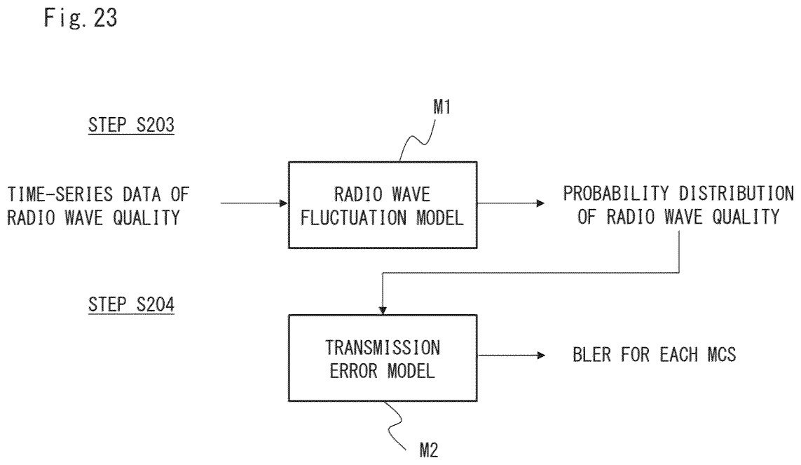

FIG. 23 illustrates input and output of the radio wave fluctuation model M1 and the transmission error model M2 in S203 and S204. As illustrated in FIG. 23, the time-series data of the radio wave quality, such as the Wideband CQI, from the radio information recording unit 120 is input to the radio wave fluctuation model M1 for which the parameters have been calculated to calculate a probability distribution (cumulative probability distribution) of the radio wave quality. Next, the probability distribution of the radio wave quality calculated by the radio wave fluctuation model M1 is input to the transmission error model M2 for which the parameters have been calculated to calculate the BLER for each MCS. For example, similarly to FIG. 14, the BLER estimation unit 150 may obtain the BLER by multiplying a cumulative probability of the radio wave quality in the SINR (SINR estimated from the CQI) calculated by the radio wave fluctuation model M1 by an error rate in the SINR calculated by the transmission error model M2. Even if the latest CQI is the same value, the estimated error rate becomes high in a case where the fluctuation is large (the probability that the quality decreases is high).

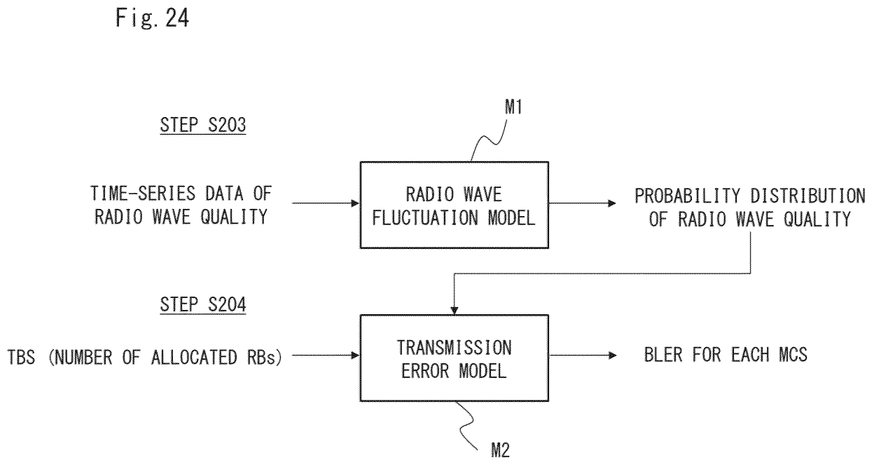

As illustrated in FIG. 24, a transport block size (TBS: the number of allocated RBs) may be input to the transmission error model M2 to calculate the BLER for each MCS. The TBS is acquired from a base station (O-DU or O-CU) via the E2 interface. Since the transmission error model M2 (a transmission error probability) is affected by the TBS, the TBS is used to correct such an influence. Since the error rate changes according to the number of RBs allocated in one slot (transmission time interval (TTI)), the BLER is calculated based on the TBS. In a case where the number of RBs is large, the frequency to be used increases. In a case where the used frequency is wide, fluctuations due to fading are averaged, and the error rate decreases. Therefore, in a case where the TBS is large, the BLER may be lowered. In a case where the TBS (or a code block size (CBS)) is small, redundant coded data decreases (a stochastic bias is likely to occur), and thus the error probability increases. For example, transmission error models of two cases of a case where the TBS is small and a case where the TBS is large may be used to obtain parameters of the model for each TBS. Not limited to the two cases, the TBS may be further divided into a plurality of stages, and a transmission error model for each of the plurality of stages may be used.

Subsequently, as illustrated in FIG. 22, the Near-RT RIC 100 determines an MCS based on the estimated BLER for each MCS (S205). The MCS determination unit 160 determines an MCS index that satisfies a target BLER based on the BLER for each MCS estimated by the BLER estimation unit 150. In a case where the BLER estimation unit 150 estimates the BLER per retransmission (per transmission), the MCS determination unit 160 may determine the MCS index from a BLER per retransmission satisfying an allowable delay.

The MCS determination unit 160 may determine the MCS in consideration of a time interval of CSI reports from UE. When a channel fluctuates, the accuracy of a precoding matrix (PM) used for beamforming or MIMO deteriorates, and the SINR decreases. In a case where the CQI and the BLER are acquired from a base station (O-DU or O-CU), pieces of frequency and time information of CSI reports for each UE are collected at the same time to determine an MCS according to the frequency and interval of the CSI reports. For example, in a case where the interval of the CSI reports is long, the MCS index may be lowered since the radio quality is likely to decrease. In a case where the interval of the CSI reports is short, the MCS index may be raised.

Subsequently, the Near-RT RIC 100 controls the RAN using the determined MCS (S206). The control information transmission unit 170 transmits the control information (MCS) determined by the MCS determination unit 160 to the E2 node 300 including either or both of the O-DU and the O-CU to control the RAN.

As described above, in the present example embodiment, an estimation model for calculating a BLER for each MCS at a next moment from the time-series data of the radio wave quality is generated using time-series data of the BLER for each MCS and the past radio wave quality at the time of learning. At the time of inference, a BLER for each MCS at each moment is calculated from the time-series data of the radio wave quality using the generated estimation model.

By two types of parameters are set in the estimation model, it is possible to estimate the next BLER for each MCS from the past radio quality and the past BLER for each MCS. A first parameter is a parameter of a portion fluctuating with time, and is a parameter to be specified as a radio quality fluctuating with time. A second parameter is a parameter of a portion not fluctuating with time, and is a parameter that specifies a relationship between an instantaneous radio quality and a BLER. In order to specify the relationship between the instantaneous radio quality and the BLER, accumulation of pieces of data is required. By the portion fluctuating with time in the first parameter is estimated and the influence thereof is removed, data to be used for calculation of the second parameter can be accumulated in a certain period of time. If the second parameter is known, a BLER for each MCS can be calculated from the first parameter. In the present example embodiment, the first parameter is estimated by the radio wave fluctuation model, and the second parameter is estimated by the transmission error model.

As a result, it is possible to accurately estimate a BLER for each MCS even in a case where the radio quality fluctuates and a target BLER is low. Further, an MCS to be set in the RAN can be determined based on the estimated BLER for each MC.

### Second Example Embodiment

Next, a second example embodiment will be described. In the present example embodiment, an example in which a learning model is used as an estimation model for estimating a BLER for each MCS will be described. The present example embodiment can be implemented in combination with the first example embodiment, and each component described in the first example embodiment may be appropriately used.

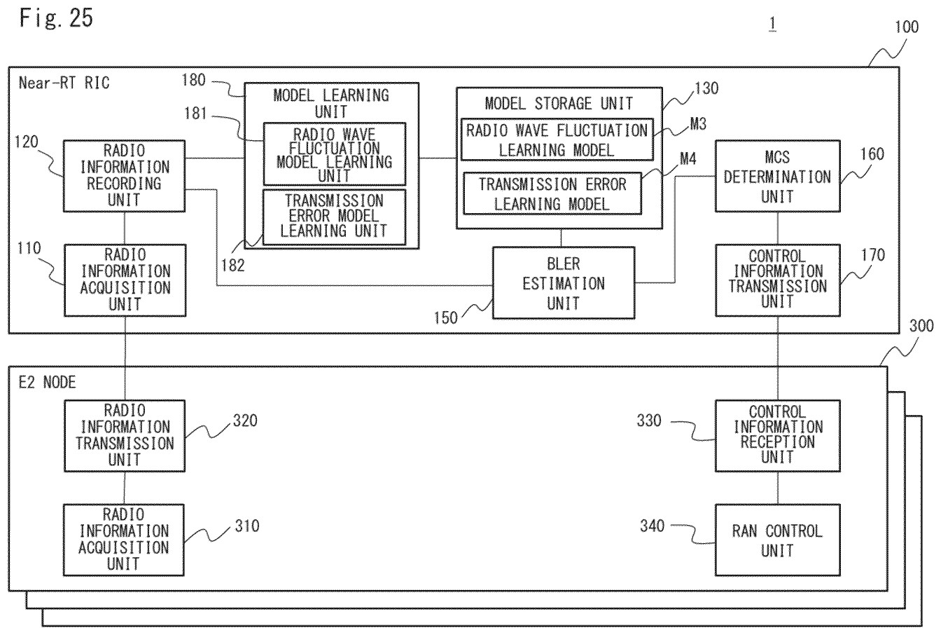

FIG. 25 illustrates a configuration example of the Near-RT RIC 100 and the E2 node 300 in the RAN system 1 according to the present example embodiment. As illustrated in FIG. 25, in the present example embodiment, the estimation model used for estimating a BLER for each MCS is stored in the model storage unit 130 of the Near-RT RIC 100. The estimation model is a model for predicting radio quality information (BLER for each CQI or BLER for each MCS) in the future (one period ahead) from time-series data of past radio quality information (BLERs for each CQI or BLERs for each MCS). The model storage unit 130 stores, as the estimation model, a radio wave fluctuation learning model M3 and a transmission error learning model M4 which are machine learning models. The radio wave fluctuation learning model M3 and the transmission error learning model M4 may be used as one learning model.

Similarly to the radio wave fluctuation model M1 of the first example embodiment, the radio wave fluctuation learning model M3 is a machine learning model for estimating a fluctuation in a radio quality (radio wave quality) from time-series data of radio quality information. The radio wave fluctuation learning model M3 is a model capable of analyzing and predicting time-series data. For example, the radio wave fluctuation learning model M3 may be a recurrent neural network (RNN), a long-short term model (LSTM), or another neural network (deep neural network (DNN)). The radio wave fluctuation learning model M3 is not limited to the neural network, and may be another learning model.

Similarly to the transmission error model M2 of the first example embodiment, the transmission error learning model M4 is a machine learning model for estimating a BLER for each MCS from the radio quality (radio wave quality) estimated by the radio wave fluctuation model M1. The transmission error learning model M4 is a model capable of analyzing and predicting time-series data. For example, similarly to the radio wave fluctuation learning model M3, the transmission error learning model M4 may be an RNN or an LSTM, or may be another neural network (DNN). The transmission error learning model M4 is not limited to the neural network, and may be another learning model.

In the present example embodiment, the Near-RT RIC 100 includes a model learning unit 180 instead of the model calculation unit 140 of the first example embodiment. The model learning unit 180 performs machine learning such as deep learning using time-series data of radio quality information received from the E2 node 300, and generates a trained estimation model. The model learning unit 180 stores the trained estimation model in the model storage unit 130. The model learning unit 180 includes a radio wave fluctuation model learning unit 181 and a transmission error model learning unit 182. The radio wave fluctuation model learning unit 181 trains the radio wave fluctuation learning model M3 using time-series data of radio quality information (Wideband CQIs or the like) and generates the trained radio wave fluctuation learning model M3. The transmission error model learning unit 182 trains the transmission error learning model M4 using an estimation result obtained by the trained radio wave fluctuation learning model M3 and radio quality information (error rates for each MCS), and generates the trained transmission error learning model M4. Other configurations are similar to those in the first example embodiment.

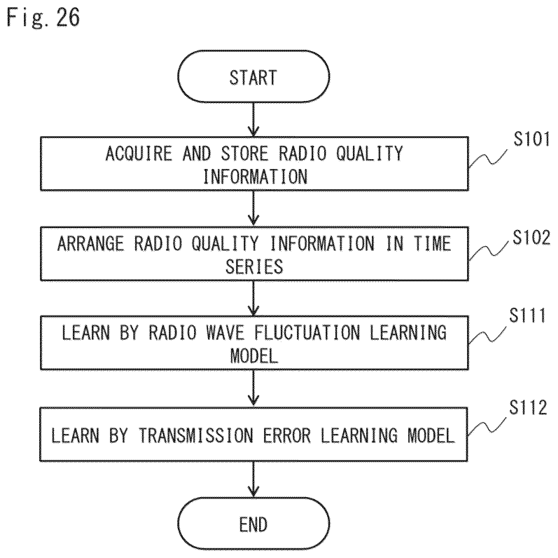

FIG. 26 illustrates an operation example of learning phase processing in the RAN system 1 according to the present example embodiment. As illustrated in FIG. 26, similarly to the first example embodiment, the Near-RT RIC 100 acquires radio quality information from the E2 node 300, stores the acquired radio quality information (S101), and arranges the stored radio quality information in time series (S102).

Subsequently, the Near-RT RIC 100 performs learning processing of an estimation model using time-series data of the radio quality information stored in the radio information recording unit 120, and generates the trained estimation model (S111 to S112). For example, the model learning unit 180 acquires time-series data of BLERs for each CQI and each MCS, divides pieces of the time-series data of the BLER for each CQI and each MCS into past data and future data, and trains the estimation model, thereby generating a model for predicting a future BLER for each CQI and each MCS from a past BLER for each CQI and each MCS.

Specifically, the radio wave fluctuation model learning unit 181 performs learning processing of the radio wave fluctuation learning model M3 (S111), and the transmission error model learning unit 182 performs learning processing of the transmission error learning model M4 (S112). The radio wave fluctuation model learning unit 181 and the transmission error model learning unit 182 store the generated trained radio wave fluctuation learning model M3 and transmission error learning model M4 in the model storage unit 130.

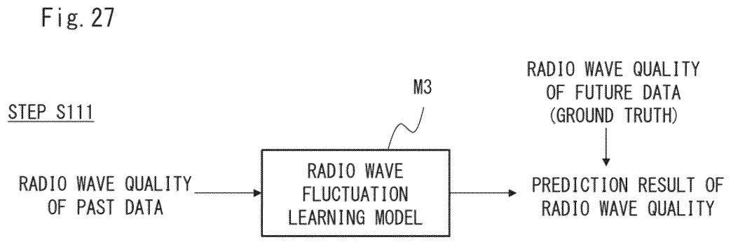

FIG. 27 illustrates input and output of the radio wave fluctuation learning model M3 in S111 (a first step of learning processing). The radio wave fluctuation model learning unit 181 inputs the time-series data of the radio wave quality such as the Wideband CQI to the radio wave fluctuation learning model M3 and trains the radio wave fluctuation learning model M3. For example, pieces of the time-series data of the radio wave quality from the radio information recording unit 120 are divided into past data and future data, and a radio wave quality of the future data of the time-series data is set as a ground truth. As illustrated in FIG. 27, a radio wave quality of the past data of the time-series data is input to the radio wave fluctuation learning model M3, and the radio wave fluctuation learning model M3 is trained so as to reduce an error between a prediction result of the radio wave quality output from the radio wave fluctuation learning model M3 and the ground truth of the radio wave quality of the future data of the time-series data.

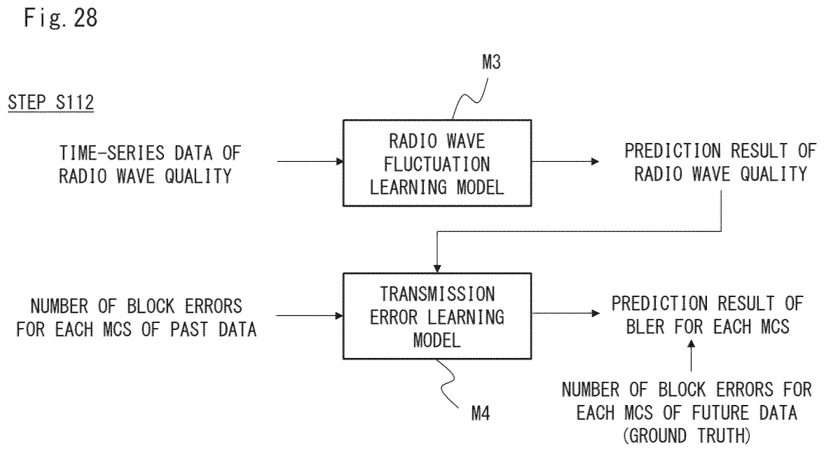

FIG. 28 illustrates input and output of the radio wave fluctuation learning model M3 and the transmission error learning model M4 in S112 (a second step of the learning process). The transmission error model learning unit 182 inputs the prediction result of the trained radio wave fluctuation learning model M3 and time-series data of the number of block errors for each MCS to the transmission error learning model M4 and trains the transmission error learning model M4. For example, pieces of the time-series data of the number of block errors for each MCS from the radio information recording unit 120 are divided into past data and future data, and the number of block errors for each MCS of pieces of the future data of the time-series data is set as a ground truth. As illustrated in FIG. 28, the time-series data of the radio wave quality, such as the Wideband CQI, from the radio information recording unit 120 is input to the radio wave fluctuation learning model M3 trained in S111 to predict a future radio wave quality. Next, the prediction result of the radio wave quality of the radio wave fluctuation learning model M3 and the number of block errors for each MCS of the past data of the time-series data are input to the transmission error learning model M4, and the transmission error learning model M4 is trained so as to reduce an error between a prediction result of a BLER for each MCS output from the transmission error learning model M4 and the number of block errors (BLER) for each MCS of the future data of the time-series data.

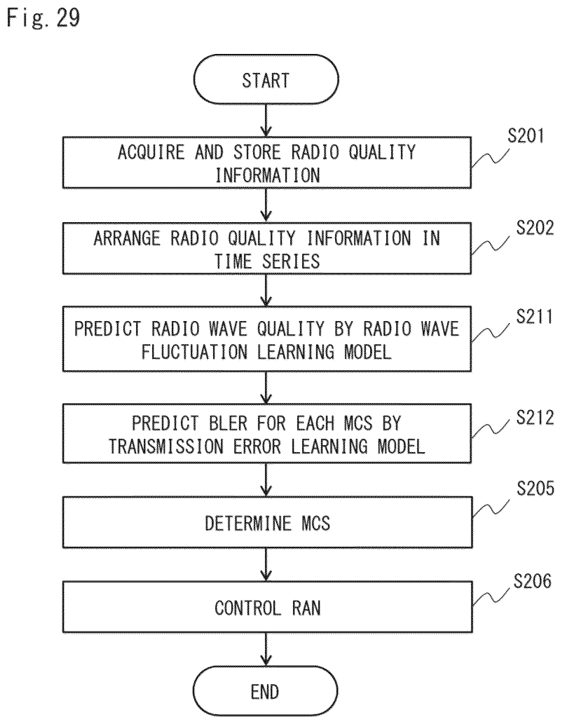

FIG. 29 illustrates an operation example of inference phase processing in the RAN system 1 according to the present example embodiment. As illustrated in FIG. 29, similarly to the first example embodiment, the Near-RT RCI 100 acquires radio quality information from the E2 node 300, stores the acquired radio quality information (S201), and arranges the stored radio quality information in time series (S202).

Subsequently, the Near-RT RIC 100 predicts a BLER for each MCS from the time-series data of the radio quality time information stored in the radio information recording unit 120 using the trained estimation model in the model storage unit 130 (S211 to S212). For example, the BLER estimation unit 150 acquires time-series data of CQIs and BLERs, and predicts a BLER for each MCS one period ahead from the acquired time-series data of CQIs and BLERs using the trained estimation model. Specifically, the BLER estimation unit 150 predicts the radio wave quality using the trained radio wave fluctuation learning model M3 (S211), and predicts the BLER for each MCS using the trained transmission error learning model M4 (S212).

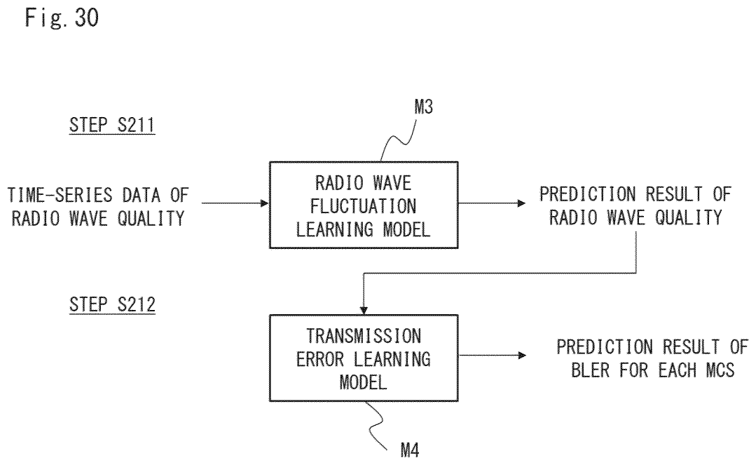

FIG. 30 illustrates input and output of the radio wave fluctuation learning model M3 and the transmission error learning model M4 in S211 and S212. As illustrated in FIG. 30, the time-series data of the radio wave quality such as the Wideband CQI from the radio information recording unit 120 is input to the trained radio wave fluctuation learning model M3 to predict a future radio wave quality. Next, the prediction result of the radio wave quality of the radio wave fluctuation model M1 is input to the trained transmission error learning model M4 to predict a future BLER for each MCS.

Thereafter, similarly to the first example embodiment, the Near-RT RIC 100 determines an MCS based on the predicted BLER for each MCS (S205), and controls a RAN using the determined MCS (S206)

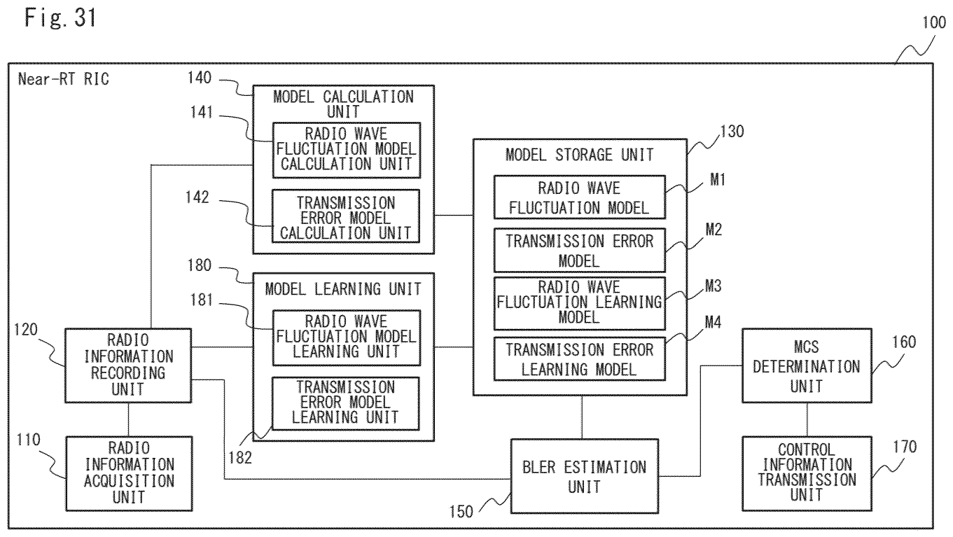

The estimation model of the first example embodiment and the estimation model of the second example embodiment may be provided, and one of the models may be selected to estimate a BLER for each MCS. FIG. 31 illustrates another configuration example of the Near-RT RIC 100 according to the present example embodiment. As illustrated in FIG. 31, the model storage unit 130 of the Near-RT RIC 100 may store the radio wave fluctuation model M1 (a radio wave fluctuation calculation model) and the transmission error model M2 (an error rate calculation model) of the first example embodiment, and the radio wave fluctuation learning model M3 and the transmission error learning model M4 of the second example embodiment. The Near-RT RIC 100 may include the model calculation unit 140 of the first example embodiment and the model learning unit 180. Either or both of the model calculation unit 140 and the model learning unit 180 may be disposed in the Non-RT RIC 200. Some or all of the radio wave fluctuation model M1, the transmission error model M2, the radio wave fluctuation learning model M3, and the transmission error learning model M4 may be stored in the Non-RT RIC 200.

Although the estimation model (a calculation model) of the first example embodiment can be trained quickly since the estimation includes approximation or the like, the estimation accuracy is likely to be limited to some extent. On the other hand, the estimation model (a learning model) of the second example embodiment requires time for training, but is likely to be superior to the estimation model of the first example embodiment in terms of the estimation accuracy. Therefore, the estimation by the estimation model of the first example embodiment and the estimation by the estimation model of the second example embodiment may be switched in accordance with a learning state. The time-series data of the radio quality information is accumulated during the operation of the Near-RT RIC 100, and the model learning unit 180 performs the learning processing of the radio wave fluctuation learning model M3 and the transmission error learning model M4 at a certain time interval. The time-series data of CQIs and the time-series data of the BLERs for each MCS are acquired from the E2 node 300, and the BLER estimation unit 150 estimates a BLER for each MCS using the estimation model (the radio wave fluctuation model M1 and the transmission error model M2) of the first example embodiment in a case where the amount of learning data is equal to or less than a certain value, and estimates a BLER for each MCS using the estimation model (the radio wave fluctuation learning model M3 and the transmission error learning model M4) of the second example embodiment in a case where the amount of learning data is equal to or more than the certain value.

A reference for selecting the estimation model may be determined by the total amount of learning data, or may be determined by the amount of data close to the behavior of a current observation value (CQI). The estimation model (learning model) of the second example embodiment may be selected in a case where there are many pieces of data close to the current observation value in the accumulated time-series data of the radio quality information, and the estimation model (calculation model) of the first example embodiment may be selected in a case where there are few pieces of data close to the current observation value in the accumulated time-series data of the radio quality information.

As described above, the estimation model may be generated by performing machine learning on the future BLER for each MCS according to the past radio quality information, and a BLER for each MCS according to radio quality information to be acquired may be estimated using the trained estimation model. As a result, the BLER for each MCS can be accurately estimated even in a case where a target BLER is low as in the first example embodiment. The use of the learning model subjected to the machine learning makes it possible to further improve the estimation accuracy.

### Third Example Embodiment

Next, a third example embodiment will be described. In the present example embodiment, an example in which a BLER is measured using a measurement bearer in an E2 node will be described. The present example embodiment can be implemented in combination with the first or second example embodiment, and each configuration described in the first or second example embodiment may be appropriately used.

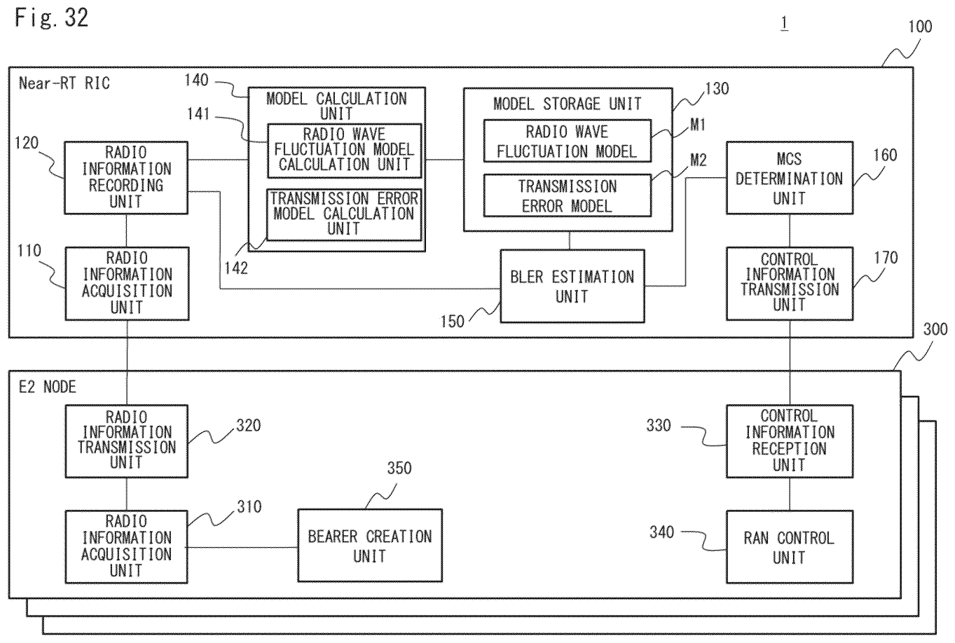

FIG. 32 illustrates a configuration example of the Near-RT RIC 100 and the E2 node 300 in the RAN system 1 according to the present example embodiment. As illustrated in FIG. 32, in the present example embodiment, the E2 node 300 includes a bearer creation unit 350 in addition to the configuration of the first example embodiment.

The bearer creation unit 350 creates a plurality of bearers for measuring a BLER for each MCS. The bearer creation unit 350 sets BLER measurement bearers between an O-DU or an O-CU and UE. The bearer creation unit 350 selects one 5G QoS indicator (5QI) for BLER measurement and creates a bearer for the selected 5QI. The bearer creation unit 350 selects a plurality of 5QIs of different classes and creates a plurality of bearers for the 5QIs.

The radio information acquisition unit 310 causes data for measurement to flow to the plurality of created bearers, and measures a BLER for each MCS. The UE may measure a downlink BLER by causing data to flow from the E2 node 300 to the UE, or the E2 node 300 may measure an uplink BLER by causing data to flow from the UE to the E2 node 300. The radio information acquisition unit 310 causes pieces of data of MCSs different for the bearers to flow and measures BLERs of the plurality of MCSs. For example, in order to acquire the BLER (the number of block errors) for each MCS as radio quality information, the Near-RT RIC 100 may specify, for the E2 node 300, a plurality of MCS indexes to be measured by the plurality of measurement bearers. The radio information acquisition unit 310 may periodically cause transport blocks made stationary by coding schemes and modulation schemes of the plurality of specified MCS indexes via the plurality of measurement bearers to measure BLERs of the plurality of MCSs. Other configurations are similar to those of the first example embodiment.

As described above, a bearer for BLER measurement may be created, and a BLER may be measured using the created bearer. By a plurality of measurement bearers are created with different classes of 5QIs and pieces of data of different MCSs are caused to flow to the bearers for measurement to measure BLERs, it is possible to efficiently measure BLERs of a plurality of MCSs at the same time. As a result, the learning speed and the inference accuracy can be improved.

### Fourth Example Embodiment

Next, a fourth example embodiment will be described. In the present example embodiment, an example in which position information is acquired from an external application server will be described. The present example embodiment can be implemented in combination with any of the first to third example embodiments, and each configuration described in any of the first to third example embodiments may be appropriately used.

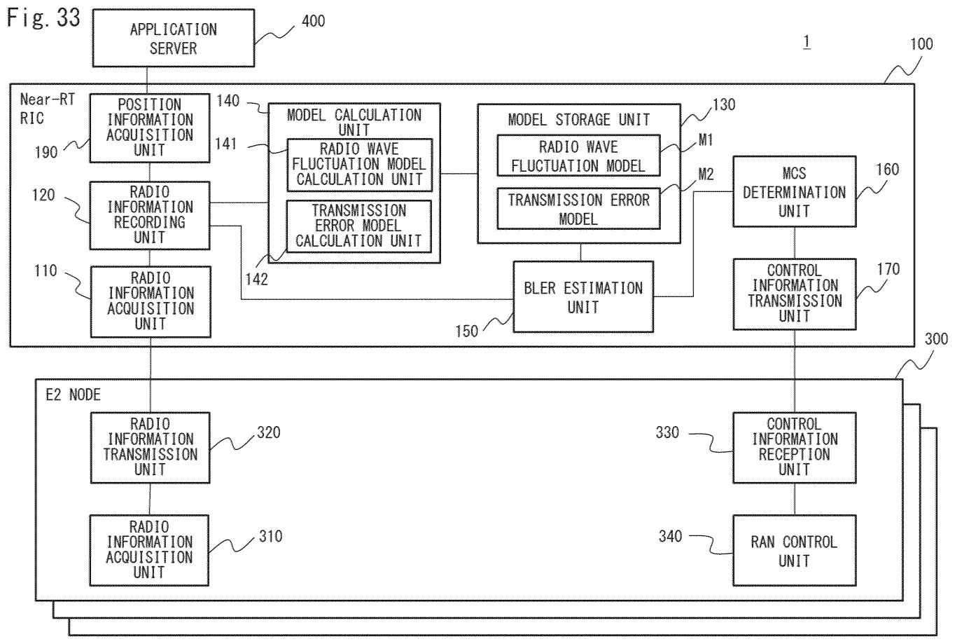

FIG. 33 illustrates a configuration example of the Near-RT RIC 100 and the E2 node 300 in the RAN system 1 according to the present example embodiment. As illustrated in FIG. 33, the RAN system 1 includes an application server 400 in addition to the configuration of the first example embodiment. For example, the application server 400 is communicably connected to the Near-RT RIC 100, but may be communicably connected to the Non-RT RIC 200.

The application server 400 is a server outside to a RAN including the E2 node 300. The application server 400 may be a physical server, a virtual server on a cloud, or a server on the Internet, for example. The application server 400 is a device that provides an application service in cooperation with the RAN and manages data related to the application. For example, the application server 400 may be a management server of an automated guided vehicle (AGV) system or an autonomous mobile robot (AMR) system, a management server of a vehicle platooning system or an autonomous driving system, or a management server of an automatic construction system. For example, the application server 400 provides position information of UE to the Near-RT RIC 100. The application server 400 may provide not only the position information of the UE but also other application data.

In the present exemplary example embodiment, the Near-RT RIC 10 includes a position information acquisition unit 190 in addition to the configuration of the first exemplary example embodiment. The position information acquisition unit 190 acquires the position information of the UE from the application server 400. The position information acquisition unit 190 may periodically acquire the position information of the UE from the application server 400 and store time-series data of the position information in the radio information recording unit 120.

The model calculation unit 140 calculates a parameter of an estimation model based on time-series data of radio quality information acquired from the E2 node 300 and the time-series data of the position information of the UE acquired from the application server 400. In a case where the learning model of the second example embodiment is used, the learning model may be generated by performing learning using the radio quality information and the position information.

The radio wave fluctuation model calculation unit 141 may calculate parameters of the radio wave fluctuation model M1 based on the position information of the UE. For example, shielding may be estimated from the position information of the UE, and the parameters of the radio wave fluctuation model M1 may be calculated based on the estimated shielding. For example, the BLER estimation unit 150 may estimate shielding from the position information of the UE, and in a case where the shielding is estimated, estimate a BLER for each MCS by the radio wave fluctuation model M1 generated in consideration of the shielding. Other configurations are similar to those in the first example embodiment.

As described above, the position information may be acquired from the application server, and learning and inference of the estimation model may be performed using the acquired position information. By the position information is input in addition to the input of the estimation model, the calculation accuracy of the BLER can be improved.

The present disclosure is not limited to the above-described example embodiments, and can be appropriately modified without departing from the scope.

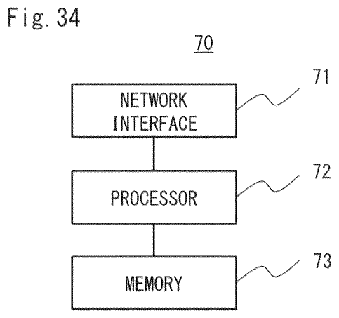

Each configuration in the above-described example embodiments may be implemented by hardware, software, or both, and may be implemented by one piece of hardware or software or by a plurality of pieces of hardware or software. Each device including the Non-RT RIC and the Near-RT RIC and each function (processing) may be achieved by a computer 70 including a network interface 71, a processor 72 such as a central processing unit (CPU), and a memory 73 which is a storage device as illustrated in FIG. 34. The network interface 71 may include a network interface card (NIC) for communicating with devices including network nodes. For example, a program for performing the method in the example embodiment may be stored in the memory 73, and each function may be achieved by executing the program stored in the memory 73 by the processor 72.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communications medium. As an example and not by way of limitation, a transitory computer-readable or communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the above-described example embodiments may be described as the following supplementary notes, but are not limited to the following supplementary notes.

### Supplementary Note 1

A system including:
an acquisition means for acquiring radio quality information from a radio network; and
a generation means for generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

### Supplementary Note 2

The system according to Supplementary Note 1, wherein
the radio wave fluctuation model is a calculation model for calculating the fluctuation in the radio wave quality by a predetermined calculation method, and
the generation means sets a radio wave fluctuation parameter used to calculate the fluctuation in the radio wave quality based on the acquired radio quality information.

### Supplementary Note 3

The system according to Supplementary Note 2, wherein
the radio wave fluctuation model is a calculation model for calculating a probability distribution of the radio wave quality, and
the generation means sets at least one of a gradient of the probability distribution and a position of a vertex of the probability distribution as the radio wave fluctuation parameter.

### Supplementary Note 4

The system according to Supplementary Note 3, wherein the generation means averages the radio wave quality of each resource block obtained from the probability distribution of the radio wave quality, and sets the radio wave fluctuation parameter based on the averaged radio wave quality and the acquired radio quality information.

### Supplementary Note 5

The system according to any one of Supplementary Notes 2 to 4, wherein the generation means sets the radio wave fluctuation parameter in accordance with shielding or interference of a radio wave in the radio network.

### Supplementary Note 6

The system according to any one of Supplementary Notes 2 to 5, wherein the generation means sets the radio wave fluctuation parameter in accordance with a spatial correlation of base stations in the radio network.

### Supplementary Note 7

The system according to any one of Supplementary Notes 2 to 6, wherein the generation means sets the radio wave fluctuation parameter based on position information of a terminal device in the radio network acquired from an external server.

### Supplementary Note 8

The system according to any one of Supplementary Notes 1 to 7, wherein
the error rate model is a calculation model for calculating an error rate for each the modulation and coding scheme by a predetermined calculation method,
the acquisition means acquires error rate information for each the modulation and coding scheme from the radio network, and
the generation means sets an error rate parameter used for the calculation of the error rate for each the modulation and coding scheme based on an estimation result of the radio wave fluctuation model and the acquired error rate information for each the modulation and coding scheme.

### Supplementary Note 9

The system according to Supplementary Note 8, wherein the acquisition means acquires the error rate information measured using a measurement bearer for each the modulation and coding scheme.

### Supplementary Note 10

The system according to Supplementary Note 8 or 9, wherein
the error rate model is a calculation model for calculating an error rate characteristic with respect to the radio wave quality for each the modulation and coding scheme, and
the generation means sets at least one of a gradient of the error rate characteristic and a position of a vertex of the error rate characteristic as the error rate parameter.

### Supplementary Note 11

The system according to Supplementary Note 10, wherein the generation means obtains a block error rate based on an error rate for each resource block obtained from the estimation result of the radio wave fluctuation model and the error rate characteristic, and sets the error rate parameter based on the obtained block error rate and the acquired error rate information for each the modulation and coding scheme.

### Supplementary Note 12

The system according to Supplementary Note 1, wherein
the radio wave fluctuation model is a learning model for predicting the fluctuation in the radio wave quality in accordance with the radio quality information, and
the generation means performs training to train the radio wave fluctuation model with the fluctuation in the radio wave quality in accordance with the radio quality information by using the acquired radio quality information.

### Supplementary Note 13

The system according to Supplementary Note 1 or 12, wherein
the error rate model is a learning model for predicting an error rate for each the modulation and coding scheme in accordance with the radio wave quality,
the acquisition means acquires error rate information for each the modulation and coding scheme from the radio network, and
the generation means performs training to train the error rate model with the error rate for each the modulation and coding scheme in accordance with the radio wave quality by using an estimation result of the radio wave fluctuation model and the acquired error rate information for each the modulation and coding scheme.

### Supplementary Note 14

The system according to any one of Supplementary Notes 1 to 13, further including an estimation means for estimating an error rate for each the modulation and coding scheme in accordance with the acquired radio quality information using the generated radio wave fluctuation model and error rate model.

### Supplementary Note 15

The system according to Supplementary Note 14, further including a determination means for determining a modulation and coding scheme to be set in the radio network based on the estimated error rate for each the modulation and coding scheme.

### Supplementary Note 16

The system according to Supplementary Note 15, wherein the determination means determines the modulation and coding scheme based on a transmission interval of a radio quality report which includes the radio quality information and is transmitted from a terminal device.

### Supplementary Note 17

The system according to Supplementary Note 15 or 16, wherein
the error rate model estimates an error rate per retransmission for each the modulation and coding scheme, and
the determination means determines the modulation and coding scheme based on the error rate per retransmission.

### Supplementary Note 18

The system according to any one of Supplementary Notes 1 to 17, further including a RAN intelligent controller (RIC) that controls a radio access network (RAN).

### Supplementary Note 19

A system including:
an acquisition means for acquiring radio quality information from a radio network; and
an estimation means for estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

### Supplementary Note 20

The system according to Supplementary Note 19, wherein
the radio wave fluctuation model is a calculation model in which a parameter is set to calculate the fluctuation in the radio wave quality by a predetermined calculation method, and
the error rate model is a calculation model in which a parameter is set to calculate the error rate for each the modulation and coding scheme by a predetermined calculation method.

### Supplementary Note 21

The system according to Supplementary Note 19, wherein
the radio wave fluctuation model is a learning model trained with the fluctuation in the radio wave quality in accordance with the radio quality information, and
the error rate model is a learning model trained with the error rate for each the modulation and coding scheme in accordance with the radio wave quality.

### Supplementary Note 22

The system according to Supplementary Note 19, wherein
the radio wave fluctuation model includes a radio wave fluctuation calculation model in which a parameter is set to calculate the fluctuation in the radio wave quality by a predetermined calculation method, and a radio wave fluctuation learning model trained with the fluctuation in the radio wave quality in accordance with the radio quality information,
the error rate model includes an error rate calculation model in which a parameter is set to calculate the error rate for each the modulation and coding scheme by a predetermined calculation method, and an error rate learning model trained with the error rate for each the modulation and coding scheme in accordance with the radio wave quality, and
the estimation means
selects the radio wave fluctuation calculation model or the radio wave fluctuation learning model and estimates the fluctuation in the radio wave quality using the selected model, and
selects the error rate calculation model or the error rate learning model and estimates the error rate for each the modulation and coding scheme using the selected model.

### Supplementary Note 23

The system according to Supplementary Note 22, wherein
the estimation means
selects the radio wave fluctuation calculation model or the radio wave fluctuation learning model based on an amount of data learned by the radio wave fluctuation learning model; and
selects the error rate calculation model or the error rate learning model based on an amount of data learned by the error rate learning model.

### Supplementary Note 24

A device including:
an acquisition means for acquiring radio quality information from a radio network; and
a generation means for generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

### Supplementary Note 25

A device including:
an acquisition means for acquiring radio quality information from a radio network; and
an estimation means for estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

### Supplementary Note 26

A method including:
acquiring radio quality information from a radio network; and
generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

### Supplementary Note 27

A method including:
acquiring radio quality information from a radio network; and
estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

### Supplementary Note 28

A non-transitory computer-readable medium storing a program for causing a computer to execute processing of:
acquiring radio quality information from a radio network; and
generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

### Supplementary Note 29

A non-transitory computer-readable medium storing a program for causing a computer to execute processing of:
acquiring radio quality information from a radio network; and
estimating an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

### REFERENCE SIGNS LIST

1 RAN system
10 first system
11 acquisition unit
12 generation unit
20 second system
21 acquisition unit
22 estimation unit
30 system
40 first device
50 second device
60 device
70 computer
71 network interface
72 processor
73 memory
100 Near-RT RIC
110 radio information acquisition unit
120 radio information recording unit
130 model storage unit
140 model calculation unit
141 radio wave fluctuation model calculation unit
142 transmission error model calculation unit
150 BLER estimation unit
160 MCS determination unit
170 control information transmission unit
180 model learning unit
181 radio wave fluctuation model learning unit
182 transmission error model learning unit
190 position information acquisition unit
200 Non-RT RIC
210 radio information acquisition unit
220 radio information recording unit
300 E2 node
310 radio information acquisition unit
320 radio information transmission unit
330 control information reception unit
340 RAN control unit
350 bearer creation unit
400 application server
M1 radio wave fluctuation model
M2 transmission error model
M3 radio wave fluctuation learning model
M4 transmission error learning model

What is claimed is:

1. A system comprising:
a memory configured to store instructions, and
a processor configured to execute the instructions to;
acquire radio quality information from a radio network; and
generate, based on the acquired radio quality information, a radio wave fluctuation model for estimating a fluctuation in a radio wave quality in accordance with the radio quality information, and generate an error rate model for estimating an error rate for each modulation and coding scheme in accordance with the radio wave quality.

2. The system according to claim 1, wherein
the radio wave fluctuation model is a calculation model for calculating the fluctuation in the radio wave quality by a predetermined calculation method, and
the processor is further configured to execute the instructions to set a radio wave fluctuation parameter used to calculate the fluctuation in the radio wave quality based on the acquired radio quality information.

3. The system according to claim 2, wherein
the radio wave fluctuation model is a calculation model for calculating a probability distribution of the radio wave quality, and
the processor is further configured to execute the instructions to set at least one of a gradient of the probability distribution and a position of a vertex of the probability distribution as the radio wave fluctuation parameter.

4. The system according to claim 3, wherein the processor is further configured to execute the instructions to average the radio wave quality of each resource block obtained from the probability distribution of the radio wave quality, and set the radio wave fluctuation parameter based on the averaged radio wave quality and the acquired radio quality information.

5. The system according to claim 2, wherein the processor is further configured to execute the instructions to set the radio wave fluctuation parameter in accordance with shielding or interference of a radio wave in the radio network.

6. The system according to claim 2, wherein the processor is further configured to execute the instructions to set the radio wave fluctuation parameter in accordance with a spatial correlation of base stations in the radio network.

7. The system according to claim 2, wherein the processor is further configured to execute the instructions to set the radio wave fluctuation parameter based on position information of a terminal device in the radio network acquired from an external server.

8. The system according to claim 1, wherein
the error rate model is a calculation model for calculating an error rate for each the modulation and coding scheme by a predetermined calculation method,
the processor is further configured to execute the instructions to acquire error rate information for each the modulation and coding scheme from the radio network, and
set an error rate parameter used for the calculation of the error rate for each the modulation and coding scheme based on an estimation result of the radio wave fluctuation model and the acquired error rate information for each the modulation and coding scheme.

9. The system according to claim 8, wherein the processor is further configured to execute the instructions to acquire the error rate information measured using a measurement bearer for each the modulation and coding scheme.

10. The system according to claim 8, wherein
the error rate model is a calculation model for calculating an error rate characteristic with respect to the radio wave quality for each the modulation and coding scheme, and
the processor is further configured to execute the instructions to set at least one of a gradient of the error rate characteristic and a position of a vertex of the error rate characteristic as the error rate parameter.

11. The system according to claim 10, wherein the processor is further configured to execute the instructions to obtain a block error rate based on an error rate for each resource block obtained from the estimation result of the radio wave fluctuation model and the error rate characteristic, and set the error rate parameter based on the obtained block error rate and the acquired error rate information for each the modulation and coding scheme.

12. The system according to claim 1, wherein
the radio wave fluctuation model is a learning model for predicting the fluctuation in the radio wave quality in accordance with the radio quality information, and
the processor is further configured to execute the instructions to perform training to train the radio wave fluctuation model with the fluctuation in the radio wave quality in accordance with the radio quality information by using the acquired radio quality information.

13. The system according to claim 1, wherein
the error rate model is a learning model for predicting an error rate for each the modulation and coding scheme in accordance with the radio wave quality,
the processor is further configured to execute the instructions to acquire error rate information for each the modulation and coding scheme from the radio network, and
perform training to train the error rate model with the error rate for each the modulation and coding scheme in accordance with the radio wave quality by using an estimation result of the radio wave fluctuation model and the acquired error rate information for each the modulation and coding scheme.

14. The system according to claim 1, wherein the processor is further configured to execute the instructions to estimate an error rate for each the modulation and coding scheme in accordance with the acquired radio quality information using the generated radio wave fluctuation model and error rate model.

15. The system according to claim 14, wherein the processor is further configured to execute the instructions to determine a modulation and coding scheme to be set in the radio network based on the estimated error rate for each the modulation and coding scheme.

16. The system according to claim 15, wherein the processor is further configured to execute the instructions to determine the modulation and coding scheme based on a transmission interval of a radio quality report which includes the radio quality information and is transmitted from a terminal device.

17. The system according to claim 15, wherein
the error rate model estimates an error rate per retransmission for each the modulation and coding scheme, and
the processor is further configured to execute the instructions to determine the modulation and coding scheme based on the error rate per retransmission.

18. The system according to claim 1, further comprising a RAN intelligent controller (RIC) that controls a radio access network (RAN).

19. A system comprising:
a memory configured to store instructions, and
a processor configured to execute the instructions to;
acquire radio quality information from a radio network; and
estimate an error rate for each modulation and coding scheme based on the acquired radio quality information by using a radio wave fluctuation model generated to estimate a fluctuation in a radio wave quality in accordance with the radio quality information and an error rate model generated to estimate an error rate for each the modulation and coding scheme in accordance with the radio wave quality.

20.-25. (canceled)

26. A method comprising:
acquiring radio quality information from a radio network; and
generating, based on the acquired radio quality information, a radio wave fluctuation model for estimating a fluctuation in a radio wave quality in accordance with the radio quality information, and generating an error rate model for estimating an error rate for each modulation and coding scheme in accordance with the radio wave quality.

27.-29. (canceled)
